(19) United States
(12) Patent Application Publication
(10) Pub. No.: US 2026/0116055 A1
(43) Pub. Date: Apr. 30, 2026

(54) Laminate Structures For Aerospace and Commercial Transportation Interiors

(71) Applicant: Schneller LLC, Kent, OH (US)

(72) Inventors: Gregory Justin Krautlarger, Kent, OH (US); Brooke Nicole Zarnosky, Canton, OH (US); Brandon Glasscock, Tallmadge, OH (US); Taylor Paige Bacon, Akron, OH (US)

(21) Appl. No.: 19/036,920

(22) Filed: Jan. 24, 2025

Related U.S. Application Data
(60) Provisional application No. 63/624,369, filed on Jan. 24, 2024.

(51) Int. Cl. B32B 27/08; B32B 5/02; B32B 7/12; B32B 27/28

(52) U.S. Cl. CPC B32B 27/08; B32B 5/02; B32B 7/12; B32B 27/281; B32B 2250/04; B32B 2262/101; B32B 2307/54; B32B 2307/718; B32B 2307/72; B32B 2307/7376; B32B 2307/738; B32B 2451/00; B32B 2605/003; B32B 2605/18

(57) ABSTRACT

The invention pertains to decorative laminate structures made with a combination of thermoplastic film and embossing resin layers with at least one layer of a thermoset polyimide. The laminate construction optimizes the low flammability characteristics, as well as providing low combustion toxicity and low smoke to comply with regulations and customer requirements. The laminates also providing formability and a lightweight, safe, and environmentally friendly material for use in the aerospace or other commercial transportation. The laminate also has high dimensional stability and tensile strength to facilitate manufacture and use, by retention of designs, textures, patterns, or three-dimensional characteristics. The laminate reduces or eliminates use of possibly hazardous flame retardant materials, and significantly reduces the weight of the laminate for various applications.

### FIELD OF THE INVENTION

The invention is directed to laminate constructions made with a series of layers to form a laminate that has characteristics for use on interior surfaces and components of aerospace or other commercial transportation. The laminates allow for significant decorative features including designs, textures, patterns, or three-dimensional characteristics, while having performance characteristics that meet and exceed standards relating to flame retardancy and related standards. The decorative laminate construction exhibits very low flammability, low combustion toxicity and low smoke characteristics, while maintaining chemical resistance, durability, and cleanability. The laminate construction also has high dimensional stability and high tensile strength and reduces the weight of the laminate.

### BACKGROUND OF THE INVENTION

Decorative and structural parts for aerospace and other commercial transportation applications may have a decorative laminate outer cover affixed to a substrate. The decorative laminates are used in a wide variety of applications, including for surfaces of interior sidewalls, ceiling panels, floor panels, overhead stowage bins, lavatory and galley panels and structures, bulkhead partitions, window shades, and other aerospace or commercial vehicle interior structural components. Non-textile flooring used in aerospace or commercial vehicle interiors may also be formed as laminate constructions. Thermoplastic laminates are used in the aerospace and commercial transportation industry due to their lightweight nature, strength, and chemical resistance properties. But the use of decorative laminates with interior parts in aerospace and like applications is limited, as such materials must meet stringent flammability safety requirements including smoke density, flame spread, and heat release values. For example, in the United States, the Federal Aviation Administration (FAA) has established Federal Aviation Regulation (FAR) Part 25.853 that sets forth the stringent standards for aircraft compartment interiors. The stringent safety standards for aircraft and commercial transportation systems used in the United States include a smoke density test specified in FAR 25.5 Appendix F, Part V Amdt 25-116. Flammability requirements include the “60 second test” specified in FAR 25.853(a) Appendix F, Part I, (a), 1, (i) and the heat release rate standard (referred to as the Ohio State University (OSU) 65/65 standard) described in FAR F25.4 (FAR Section 25, Appendix F, Part IV), or the French flame retardant tests such as, NF-P-92-504 (flame spread) or NF-P-92-505 (drip test). Other territories have similar stringent standards, such as set by European Union Aviation Safety Authority (EASA), or even manufacturers such as Airbus SE, have flammability and smoke density and other safety requirements that are imposed on suppliers of laminate materials. These flammability safety requirements provide that, in the event of a fire, components made from materials meeting these requirements can increase the amount of time available for escape and provide for better visibility and less toxicity during a fire.

Prior laminate constructions using thermoplastic materials together with an embossing resin layer still present challenges to achieving the desired flammability characteristics for aerospace or other commercial transportation applications. Therefore, further flame retardants (FR) are typically used in association with the thermoplastic layers or adhesive layers used in the laminate construction. Such flame retardants undesirably add weight and are themselves potentially toxic or hazardous during a fire, with many FR materials themselves being regulated as understanding of toxic materials increases.

For interior parts of an aircraft cabin or the like, it is many times desired that the decorative laminate is formable, such as by vacuum and pressure forming and/or thermoforming. The substrate and other layers of the laminate have therefore been formed of thermoplastic materials such as polyvinyl chloride (PVC) and polyvinyl fluoride (PVF) for example, and thermoset materials are not used.

The aesthetics of the decorative laminate are also key to the comfort of passengers, and the decorative laminate may include textures or other features to enhance aesthetics. The laminate may be embossed using a hot press process for example. During the press cycle, an embossing resin in the laminate is molded with a three-dimensional pattern to provide an aesthetically pleasing embossed or textured surface on the decorative laminate. It is desired that the embossing resin and laminate structure provides for texture retention within the decorative laminate, to be visually and tactilely pleasing to passengers. The dimensional stability and tensile strength of the decorative laminate are important to the retention of embossing/texturing features, as well as other features such as designs, in the laminate. It would also be desirable to provide a laminate with high dimensional stability and high tensile strength characteristics as desired, while not unduly increasing the weight of the laminate or limiting the formability of the laminate. There remains the need for decorative laminates that allow for embossing/texturing and have excellent dimensional stability and tensile strength, while still meeting the stringent flammability requirements, being formable and being lightweight.

### SUMMARY OF THE INVENTION

According to a first aspect of the invention, there is provided a laminate comprising a plurality of layers forming a sheet having decorative features selected from textures, three-dimensional depth or combinations thereof, the plurality of layers including a base layer with a predetermined thickness to serve as a backing for application to a surface, at least one intermediate layer with a predetermined thickness forming to allow forming of decorative features, textures, three-dimensional depth or combinations thereof in the laminate, and a top protective layer of thermoplastic material having a predetermined thickness, wherein at least one layer of thermoset polyimide having a predetermined thickness is provided below the intermediate layer, wherein the laminate has predetermined combustion reaction properties of smoke density, smoke toxicity, resistance to sustained ignition and heat release properties for use in a commercial passenger vehicle interiors.

At least one layer of thermoset polyimide may be the base layer of the laminate.

At least one layer of thermoset polyimide may have a thickness of between 0.5 to 10.0 mils (0.0127 to 0.254 mm), with the thickness being variable to provide predetermined performance characteristics selected from the characteristics including tear resistance, tensile strength, dimensional stability, weight of the laminate or combinations thereof.

A layer of adhesive may be provided on the base layer for application to a substrate surface.

The intermediate layer may be formed of embossing resin having a thickness to allow at least one different depth portion to be formed in the laminate top surface.

The intermediate layer may be formed of embossing resin having a thickness of between 1.5 mils up to 8.0 mils (0.0381 to 0.2032 mm).

The embossing resin layer may have a thickness of at least 4.0 mils.

The at least one layer of thermoset polyimide has a thermal decomposition temperature in the range of 500° C. to 600° C. (932° F. to 1112° F.), and no glass transition temperature.

The base layer may be formed of an embossing resin with a predetermined thickness, and the at least one thermoset polyimide layer is provided on top of the base layer, and wherein the intermediate layer is provided on top of the at least one thermoset polyimide layer.

The intermediate layer may be an embossing resin layer having a predetermined thickness to allow forming of decorative features, textures, three-dimensional depth, or combinations thereof in the laminate.

The base layer may be formed of a thermoplastic formable substrate and a layer of adhesive is provided on the base layer with an embossing resin layer with a predetermined thickness provided on the adhesive layer. The at least one thermoset polyimide layer may be provided on top of the embossing resin layer. The intermediate layer may be provided on top of the at least one thermoset polyimide layer.

The intermediate layer may be an embossing resin layer having a predetermined thickness to allow forming of decorative features, textures, three-dimensional depth, or combinations thereof in the laminate.

The base layer may be formed of a glass reinforced prepreg. The at least one thermoset polyimide layer may be provided on top of the glass reinforced prepreg layer. The intermediate layer may be provided on top of the at least one thermoset polyimide layer and may be formed of an embossing resin having a predetermined thickness to allow forming of decorative features, textures, three-dimensional depth, or combinations thereof in the laminate.

The base layer may be formed of a glass reinforced prepreg. A layer of glass with resin may be provided on the base layer with the at least one thermoset polyimide layer provided on top of the glass with resin layer. The intermediate layer may be provided on top of the at least one thermoset polyimide layer and may be formed of an embossing resin having a predetermined thickness to allow forming of decorative features, textures, three-dimensional depth or combinations thereof in the laminate.

The laminate may have a total and peak heat release, as measured by the OSU heat release test, of less than 55 kW/m² for peak heat release and 55 kW·min/m² for total heat release and the measurement of smoke release according to the FAR 25.853, Appendix F, Parts IV and V is less than 200.

The thermoset polyimide may have a density range of 1.3 to 1.5 g/cm³. The use of other flame retardant layers in the laminate may be reduced or eliminated. Total and peak heat release, as measured by the OSU heat release test, may be less than 65 kW/m² for peak heat release and 65 kW·min/m² for total heat release and the measurement of smoke release according to the FAR 25.853, Appendix F, Parts IV and V is less than 200.

The weight per unit area of the laminate may be less than 260 g/m² as measured under ISO 3801 method 5.

The laminate may have a tensile strength of least 175 N/25 mm.

The laminate may be formable in a dome mold thermoforming test at a vacuum pressure of 4 in Hg using the thermoforming temperatures between 70° C. to 225° C., to a depth of at least a 3.0 inch draw using a thermoset polyimide layer having a thickness of 2.0 mil or less, with the laminate having weight per area range of 150 to 700 g/m².

According to a second aspect of the invention, there is provided a decorative laminate comprising a plurality of layers forming a sheet with a base layer to serve as a backing for application to a surface, at least one intermediate layer and a top layer, with at least one layer of a thermoset polyimide with a thickness of between 0.5 to 10.0 mils (0.0127 to 0.254 mm) and the at least one intermediate layer including a layer of embossing resin disposed between the at least one layer of a thermoset polyimide and the top layer with a thickness of between 1.0 to 60.0 mils (0.0254 to 1.524 mm), wherein at least one layer of thermoset polyimide has a thermal decomposition temperature in the range of 500° C. to 600° C. (932° F. to 1112° F.) and no glass transition temperature.

The present invention provides significant improvement in the flame retardant performance, and FAR 25.853 rating, of a laminate construction having other desired characteristics for use in aerospace and commercial transportation. The improved laminate construction utilizes a combination of protective layers and decorative layers in the laminate that together provide significantly improved flammability characteristics. A laminate construction comprises at least one base layer, at least one intermediate layer such as an embossing resin layer and a protective layer overlying the embossing resin layer. At least one layer of a thermoset polyimide (PI) layer is provided in the laminate construction below an intermediate layer, having a predetermined thickness. The laminate may be an ultrathin decorative laminate that is highly formable or a Non-textile Flooring (NTF) laminate for example.

The laminate of the invention also provides significant benefits of high dimensional stability and tensile strength while reducing the weight of the decorative laminate and being optimized to allow formability. The improved laminate construction is formable to be used on various surfaces and components in aerospace and commercial transportation applications. For a decorative laminate or NTF laminate, the protective layer may be transparent or semi-transparent, and may be formed from a thermoplastic material. The protective layer has an outer surface that faces the environment and an inner surface laminated to an embossable resin material layer or other layer such as a decorative ink layer. The embossable resin layer has a predetermined thickness to provide desired texture or three-dimensional features to the resulting laminate. At least one layer of a thermoset polyimide film is provided as the base layer or an interior layer of the decorative laminate and non-textile flooring (NTF) products, resulting in a significant improvement in flame retardancy. The layers are laminated together to form the improved laminate.

The laminate of the invention is tailored for the aerospace and commercial transportation industry and has the following features. The laminate more easily passes “Flammability, Smoke, and Toxicity” (“FST”) and heat release requirements for Original Equipment Manufacturers (“OEMs”) and regulatory agencies. The laminate is lightweight compared to current products, which translates into fuel savings for airlines or the like. The laminate also passes standard physical requirements for use in aerospace and commercial transportation, such as impact resistance, cleanability and other characteristics. The laminate has high dimensional stability and tensile strength to facilitate manufacture and retention of design, shape, texture, three-dimensional depth features or combinations thereof, but is also optimized to be formable to a substrate using forming processes.

These and other aspects of the invention are herein described in detail, with reference to the accompanying drawings and examples, which are representative of some of the alternative ways in which the concepts of the invention may be practiced.

### BRIEF DESCRIPTION OF THE FIGURES

FIG. 1 is a schematic illustration of an example structure forming a laminate in accordance with the present invention.

FIG. 2 is a schematic illustration of another example structure to form a laminate in accordance with the present invention.

FIG. 3 is a schematic illustration of another example structure to form a laminate in accordance with the present invention.

FIG. 4 is a schematic illustration of another example structure to form a laminate in accordance with the present invention.

FIG. 5 is a schematic illustration of another example structure to form a laminate in accordance with the present invention.

FIG. 6 is a schematic illustration of another example structure to form a laminate in accordance with the present invention.

FIG. 7 is a schematic illustration of the polymerization process to form polyamic acid to form the thermoset polyimide layer for the laminate in accordance with the present invention.

FIG. 8 is a schematic illustration of the imidization and annealing process to form the thermoset polyimide layer for the laminate in accordance with the present invention.

FIG. 9 shows the data from evaluating tear strength in FIG. 9A, tensile strength in FIG. 9B and laminate weight in FIG. 9C for different thicknesses of a thermoset polyimide layer used in a laminate in accordance with the present invention.

### DETAILED DESCRIPTION

The examples as described herein are intended to indicate a few of the possible arrangements to achieve a laminate according to the invention. The laminate may have decorative features selected from design, shape, texture, three-dimensional depth, or combinations thereof. For example, the illustrative embodiments may be decorative composite structures with a customized appearance for applications in association with commercial transport vehicle interiors such as aerospace or other transportation interiors. The laminate includes at least one layer of predetermined type of thermoset polyimide film with predetermined thickness, that achieve improved performance for these applications as compared to traditional aerospace laminates. The laminate construction optimizes the flame retardancy of aerospace or the like interior laminates, provides formability and a lightweight, safe, and environmentally friendly material for use in the aerospace or other commercial transportation industry. The use of at least one layer of a thermoset polyimide film in conjunction with thermoplastic layers enables ongoing compliance with evolving and more stringent regulations, reduces or eliminates the reliance on flame retardants, and allows for potential weight reduction, thereby enhancing overall performance and safety for these applications. The examples provide a laminate structure for aerospace or other commercial transportation having flame retardancy characteristics that more effectively meet or exceed required heat and flame resistance requirements and regulations for such applications. This is accomplished while reducing weight and enabling formability and design features that include shape, texture, three-dimensional depth, or combinations thereof.

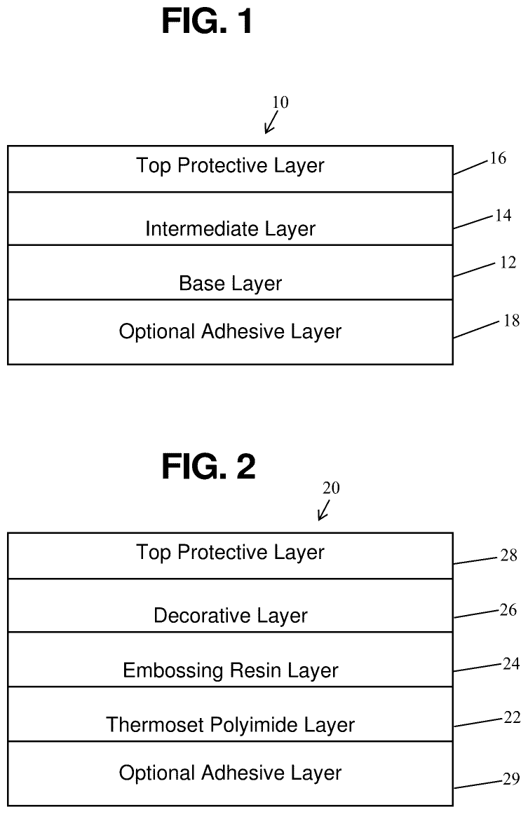

With reference to FIG. 1, a laminate construction 10 according to an example has at least a base layer 12 with a predetermined thickness to serve as a backing for application to a surface for example. An intermediate layer 14 with a predetermined thickness may provide decorative features to the resulting laminate 10. Generally, the laminate 10 is desired to have a textured decorative layer 14 formed of an embossing resin with a significant thickness. A top protective layer 16 composed of a thin layer of thermoplastic, provides desired impact resistance, cleanability and other characteristics in combination with the laminate 10. The improved flame-retardant thermoplastic laminate 10 is particularly designed for use in aerospace and aviation or other commercial transportation interiors. By incorporation of predetermined thicknesses and types of thermoset polyimide resin-based films onto thermoplastic layers in the laminate construction, there are significant enhancements the laminate 10 provides. These include improved flame retardancy that more effectively achieves required flame retardancy performance characteristics for aerospace or like applications, enhanced formability with vacuum and pressure forming processes, improved dimensional stability, high tensile strength, and lighter weight. The thickness and type of thermoset polyimide resin-based films positioned below the top protective thermoplastic layer 16 provide these enhanced performance characteristics in conjunction with the other layers and allow optimization for different applications. An optional adhesive layer 18 may be provided on the base layer 12, for application to a surface for example. Alternately, a surface may have an adhesive applied to it, with the laminate then adhered thereto.

The laminate 10 of this and other examples is an ultra-thin laminate designed specifically for aerospace or similar commercial transportation applications where stringent flame retardance, smoke density, smoke toxicity, resistance to sustained ignition and heat release properties must be met. In addition, the laminate is more environmentally friendly as it does not require materials that are or may be considered environmentally objectionable. As the traditional flame retardants currently used in aerospace laminate materials are subject to evolving regulations and environmental concerns, such regulations may change and result in prohibiting the use of flame retardants based on environmental or safety concerns. For example, flame retardants have included halogen-based flame retardants, antimony-based flame retardants, metal hydroxide-based flame retardants, phosphoric-acid-ester-based flame retardants, and the like, which have been more highly regulated. Halogenated compounds and other compounds have raised concerns due to their potential adverse environmental and health effects. These flame retardants can release toxic gases and smoke when exposed to fire, posing risks to both the environment and human health. As an example, flame retardants previously used in aerospace laminate constructions included a chemical decabromodiphenyl ether (DecaBDE), which has now become restricted due to hazardous or environmental factors as determined by regulatory bodies. In this event, a laminate using such materials would then have to be reformulated to remove the material, requiring requalification and validation before such reformulated laminate could be used on aircraft or the like. As awareness of environmental and health concerns associated with flame retardants grows, there is an increasing emphasis on regulatory compliance and the use of safer alternatives. To assess the potential health hazards of aircraft interior laminates, several toxicity tests are also conducted under FAR 25.853. The major toxic gas test performed is AITM 3.0005 (Airbus) and BSS 7239 (Boeing). These tests aim to evaluate the materials' safety in terms of toxic gas emissions, and off-gassing. This test analyzes and quantifies gases like carbon monoxide, hydrogen cyanide, hydrogen chloride, and volatile organic compounds. Another test commonly performed includes the smoke density test AITM 2.0007 (Airbus) and BSS 7238 (Boeing), which measures the opacity of smoke produced by burning materials. These tests ensure compliance with safety standards and regulations set by aerospace/aviation authorities like the FAA and EASA. The objective of these toxicity tests is to ensure that aircraft interior laminates meet stringent safety requirements. They help identify any potential risks associated with smoke, toxic gas emissions, and off-gassing during fire incidents or normal operating conditions. By assessing the materials' performance in these tests, aviation authorities can ensure the safety and well-being of aircraft occupants and crew members, mitigating the potential health hazards that may arise in emergency situations. These tests play a crucial role in maintaining the high safety standards of aircraft interiors and contribute to overall aviation safety. The laminate 10 effectively complies with the regulations without the use of harmful or potentially harmful or environmentally objectionable materials. The laminate may be a decorative laminate that is used on various interior components, like sidewalls, floors, panel coverings, window surrounds, partitions, bulkheads, ceilings, and stowage compartments, and together with the substrate on which it is applied, must withstand fire, and emit minimum quantities of smoke and/or other toxic fumes during combustion. The laminate also provides significant aesthetic appeal for passengers.

In the laminate 10 of this and other examples, by substituting possibly harmful flame retardants with a thickness of thermoset polyimide film, it is found that the flammability performance of the laminate is significantly improved. The ability to effectively comply with the regulations now and in the future while reducing or even eliminating the need for such hazardous FR additives provides significant advantage. By substituting a particular type of non-toxic thermoset polyimide film in the construction of laminate 10 in this and other examples, the laminates align with evolving regulations and standards. The laminate may thus avoid the need to use regulated flame-retardants or derivatives that may be banned or restricted in the future. The ability of laminate 10 in this and other examples to reduce product toxicity offers significant advantages, as emphasizing reduced toxicity demonstrates a commitment to safety and compliance with regulations and industry standards.

The laminates of the invention are preferably designed to have a precise weight per area range of 150 to 700 g/m², making them exceptionally lightweight, which is particularly helpful for commercial transportation applications. In commercial transportation applications, the decorative laminates are specifically intended for direct application onto interior passenger compartment surfaces and applied to thermoplastic or other substrates or interior sidewall panels for example. For example, interior sidewall panels in aircraft are typically constructed using lightweight composite materials. These composites feature a honeycomb core that is sandwiched between reinforced composite skins, typically made of carbon fiber or fiberglass. This construction technique offers a combination of strength, durability, and fire resistance while effectively reducing the overall weight and improving fuel efficiency. For NTF products, the laminate is intended to be applied directly to the floor substrate in the interior passenger compartment of the commercial transportation vehicle. The laminate 10 in this and other examples, with the targeted weight per area range of 150 to 700 g/m² is applied to a substrate and ensures compliance with the necessary requirements and regulations in combination with the substrate.

In a further example as shown in FIG. 2, a laminate 20 includes a base layer 22 of a thermoset polyimide resin or film with a predetermined thickness to serve as a backing for application to a surface for example. In this example, the thermoset polyimide resin or film 22 has a predetermined thickness, such as between 0.5 to 6.0 mils (0.0127 to 0.1524 mm). On the base layer 22, an embossing resin layer 24 is provided, with a thickness of between 1.0 to 4.0 mils (0.0254 to 0.1016 mm). The embossing resin layer may be formed of polyvinyl chloride (PVC), vinyl acetate (VA), polycarbonate (PC), acrylonitrile butadiene styrene (ABS), polyurethane (PU), polyetheretherketone (PEEK), polyphenylene sulfide (PPS), polyetherimide (PEI) or polyamide (PA) for example. A decorative ink layer 26 is provided adjacent the embossing resin layer 24, with a thickness of 0.01 to 2.0 mil (0.000254 to 0.0508 mm) for example. A top protective thermoplastic layer 28 having a thickness of about between 0.5 to 4.0 mils may be formed of polyvinyl fluoride (PVF), polyvinylidene fluoride (PVDF), thermoplastic polyurethane (TPU), polyvinyl chloride (PVC), ethylene tetrafluoroethylene (ETFE), polytetrafluoroethylene (PTFE), polyethylene (PE), perfluoroalkoxy alkane (PFA) or polycarbonate (PC) for example, and provides desired impact resistance, cleanability and other characteristics in combination with the laminate 20. The decorative ink layer 26 may be printed or otherwise applied on the back of the protective layer 28, with color or design visible through protective layer 28. The laminate 20 may be designed to be formable along with a surface or substrate on which it is applied. The range of thicknesses for formable substrates generally is between 0.010 inches and 0.5 inches. The laminate 20 provides a combination of various thicknesses of thermoplastic materials to produce decorative laminate 20, in combination with the thermoset polyimide film of a predetermined thickness in the construction, such as ranging from 0.5 to 6.0 mils (0.0127 to 0.1524 mm). This combination enhances flammability resistance of the overall construction and provides other significant benefits. The thermoset polyimide film 22 may be coated with a 0.1 to 0.5 mil (0.000254 to 0.0127 mm) thickness of laminating adhesive 29 before final lamination. Alternatively, in some cases, the adhesive 29 may already be applied to a surface or substrate, allowing direct lamination of the thermoset polyimide film base layer 22 thereon. The adhesive layer 29 may be a pressure sensitive or heat activated adhesive, and may be formed of acrylic, silicone, epoxy, or a polyurethane based adhesive for example.

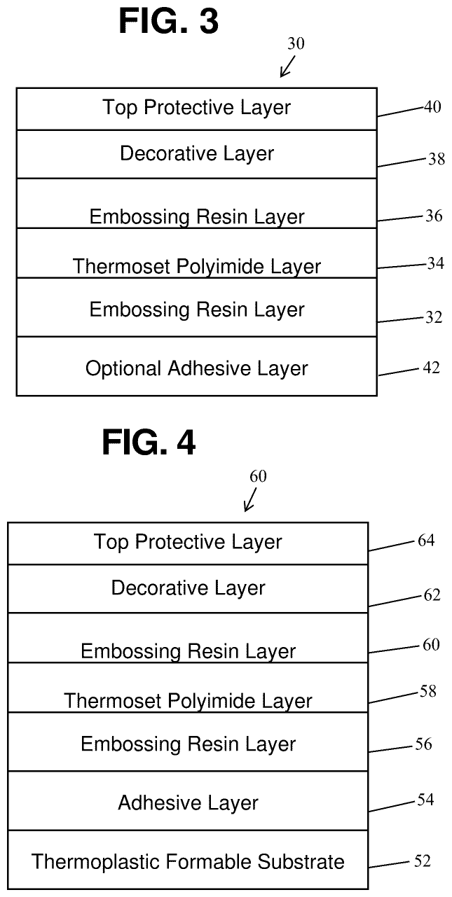

In another example as shown in FIG. 3, a laminate 30 includes a base layer 32 of an embossing resin, with a thickness of between 1.0 to 4.0 mils. The embossing resin layer 32 may be formed of polyvinyl chloride (PVC), vinyl acetate (VA), polycarbonate (PC), acrylonitrile butadiene styrene (ABS), polyurethane (PU), polyetheretherketone (PEEK), polyphenylene sulfide (PPS), polyetherimide (PEI) or polyamide (PA) for example. A layer of thermoset polyimide resin or film 34 is provided on top of the base layer 32, with a predetermined thickness, such as between 0.5 to 6.0 mils (0.0127 to 0.1524 mm). On the thermoset polyimide layer 34, another embossing resin layer 36 is provided, with a thickness of between 1.0 to 4.0 mils (0.0254 to 0.1016 mm). A decorative ink layer 38 is provided adjacent the embossing resin layer 36, with a thickness of 0.01 to 2.0 mil (0.000254 to 0.0508 mm) for example. A top protective thermoplastic layer 40 having a thickness of about between 0.5 to 4.0 mils (0.0127 to 0.1016 mm) may be formed of polyvinyl fluoride (PVF), polyvinylidene fluoride (PVDF), thermoplastic polyurethane (TPU), polyvinyl chloride (PVC), ethylene tetrafluoroethylene (ETFE), polytetrafluoroethylene (PTFE), polyethylene (PE), perfluoroalkoxy alkane (PFA) or polycarbonate (PC) for example. This combination of embossing resin layers 32 and 36 and a layer of thermoset polyimide film 34 enhances flammability resistance of the overall construction, while providing embossing layers that allow for significant design and relief or textural features to be formed in the final laminate 30. The base embossing resin layer 32 may be coated with a 0.1 to 0.5 mil (0.00254 to 0.0127 mm) thickness of laminating adhesive 42 before final lamination. Alternatively, in some cases, the adhesive 42 may already be applied to the substrates, allowing direct lamination of the base layer 32 thereon. The adhesive layer 42 may be a pressure sensitive or heat activated adhesive, and may be formed of acrylic, silicone, epoxy, or a polyurethane based adhesive for example.

In another example as shown in FIG. 4, a laminate 50 includes a base layer 52 of a thermoplastic formable substrate. The thermoplastic formable substrate 52 may be a 1.0 to 500 mil (0.0254 to 12.7 mm) thick substrate formed of polyetheretherketone (PEEK), polyphenylene sulfide (PPS), polyetherimide (PEI), polyamide (PA), polycarbonate (PC), polyvinyl chloride (PVC), acrylonitrile butadiene styrene (ABS) or thermoplastic polyurethane (TPU) for example. The base substrate 52 provides a surface that can be formed in conjunction with a support surface in the passenger cabin of an aerospace or other commercial transportation vehicle, such as by vacuum and pressure forming. These are two common thermoplastic forming techniques used in the aerospace industry to make interior sidewalls and components for example. Alternatively, thermoforming may be used to form the laminate 50, with the base substrate 52 and thermoset polyimide layer 54 enhancing the formability and retention of the form in manufacture and use.

In conjunction with the base substrate layer 52, the laminate 50 has a 0.5 to 10.0 mil (0.0127 to 0.254 mm) thickness of adhesive 54 on base layer 52. The adhesive layer 54 may be a pressure sensitive or heat activated adhesive, and may be formed of acrylic, silicone, epoxy, or a polyurethane based adhesive for example. A thermoset polyimide resin or film layer 56 has predetermined thickness, such as between 0.5 to 6.0 mils (0.0127 to 0.1524 mm). In conjunction with the base substrate layer 52, the thermoset polyimide layer 56 provides significantly enhanced flammability performance for use in passenger cabins of aerospace or other commercial transportation. On the thermoset polyimide layer 56, an embossing resin layer 58 is provided, with a thickness of between 1.0 to 4.0 mils (0.0254 to 0.1016 mm). The embossing resin layer 58 may be formed of polyvinyl chloride (PVC), vinyl acetate (VA), polycarbonate (PC), acrylonitrile butadiene styrene (ABS), polyurethane (PU), polyetheretherketone (PEEK), polyphenylene sulfide (PPS), polyetherimide (PEI) or polyamide (PA) for example. A decorative ink layer 60 is provided adjacent the embossing resin layer 62, with a thickness of 0.01 to 4.0 mil (0.000254 to 0.1016 mm) for example. A top protective thermoplastic layer 64 having a thickness of about between 0.5 to 4.0 mils (0.0127 to 0.1016 mm) may be formed of polyvinyl fluoride (PVF), polyvinylidene fluoride (PVDF), thermoplastic polyurethane (TPU), polyvinyl chloride (PVC), ethylene tetrafluoroethylene (ETFE), polytetrafluoroethylene (PTFE), polyethylene (PE), perfluoroalkoxy alkane (PFA) or polycarbonate (PC) for example. The laminate 50 may thus be designed to be formable along with the base substrate layer 52. The range of thicknesses for formable substrates generally is between 0.010 inches and 0.5 inches (0.254 to 12.7 mm), and with the thermoset polyimide layer 56 provide the ability to combine with various thicknesses of thermoplastic layers to enhance flammability resistance and performance of the overall construction.

Also, the thermoset polyimide layer(s) may be combined with other flame retardant layers in the construction, further optimizing the flammability characteristics based on the combined effects of all the flame retardant components in the laminate. This enhanced flammability resistance is achieved while allowing formability, embossing and other significant performance characteristics for use in aerospace or other commercial transportation.

In this and other examples, the construction of the laminate provides combinations of layers for applications in relation to passenger compartments in commercial transportation vehicles and the like. For example, in relation to wall panels used in the cabin, an extremely light weight laminate may be provided, which provides the desired flammability characteristics as well as providing formability and a decorative and aesthetically pleasing appearance with texture and form, when applied to a substrate in the passenger compartment. For other applications, a decorative laminate having high tensile strength and dimensional stability is required. This high tensile strength and dimensional stability in a thin decorative laminate typically required use of materials such as a woven glass layer to provide such characteristics. A disadvantage of using a woven glass layer to provide desired high tensile strength and dimensional stability is that such a layer is thick and adds significantly to the weight per unit area of a laminate. The use of a woven glass layer also limits the formability of the laminate, as it is designed not to stretch to retain the high dimensional stability.

The laminates of the invention provide high tensile strength and dimensional stability, without the use of materials such as a woven glass layer in the laminate. This makes the laminate ideally suited for areas where weight is important but increased abuse is expected. The thermoset polyimide layer of a predetermined thickness provides the laminate with high tensile strength and very low elongation to be formed. This allows high dimensional stability after going through processing steps due to the inability to inadvertently stretch the material with web processing equipment or the like. The thermoset polyimide layer in the laminate also eliminates the need for a heavy woven glass layer, which will make the laminate lighter weight. In addition, even though the laminate made with thermoset polyimide film is difficult to stretch, it is still optimized to be formable as the thickness of the thermoset polyimide layer is small enough to allow for laminate stretching when exposed to vacuum and pressure forming processes for example. As these are two common thermoplastic forming techniques used in the aerospace industry, a heavier duty laminate material may be provided that provides the desired high dimensional stability and tensile strength while still being formable. The high dimensional stability provided by the laminate with at least one thermoset polyimide layer ensures the material does not warp after or during installation. This is especially important when geometric decorative prints are being used or when splicing two panels together for a seamless transition for example. The laminate construction allows optimizing the amount of stretch and dimensional stability allowed, based on the predetermined thickness of a thermoset polyimide as used in combination with other thermoplastic layers. The thickness of the thermoset polyimide layer can be tailored or optimized to create enough resistance to stop stretching, but still allow a low enough resistance for thermoforming, vacuum forming or other forming processes. For example, a 1.0 mil (0.0254 mm) thermoset polyimide layer provides an amount of dimensional stability while still be extremely formable. Thicker thermoset polyimide layers may be used for other applications where higher dimensional stability is required, but some formability is still desired.

The laminate of this and other examples also provide the ability to incorporate texture or relief to the laminate for aesthetic appeal. The embossing layer 58 in this and other examples plays a crucial role in adding texture and visual appeal to the laminate 50. One important consideration in laminate embossing is the thickness of the embossing layer itself. Thicker embossing layers are often preferred to help form and retain the desired texture or three-dimensional characteristics and enhance the overall quality of the embossed surface. When embossing, a pattern or design is pressed into the material, creating raised or indented areas. Thicker embossing layers provide more material to accommodate the depth and intricacy of the embossed pattern. This helps ensure that the texture remains distinct and well-defined, enhancing the tactile and visual experience of the final product. If the embossing layer is too thin, several issues can arise. Firstly, the lack of sufficient material depth can result in a shallow or indistinct embossed pattern. Fine details may not be adequately captured, leading to a loss of texture and overall aesthetic appeal. Additionally, a thin embossing layer may be more susceptible to damage or wear over time. It may lack the necessary durability to withstand handling, friction, or other environmental factors, potentially compromising the longevity of the embossed surface. Furthermore, a thin embossing layer may not provide enough contrast with the surrounding material. This can make the embossed pattern less visually prominent or easily overlooked. On the other hand, increased thickness of embossing layers provides enhanced contrast and visibility, effectively highlighting the texture. The embossing layer(s) of the laminate may be in the range of 1.5 mils up to 8.0 mils, with the use of thicker layers providing unique textural design features. A thickness of at least 3.0 mils may be used to allow desired textures or three-dimensional features to be formed. The laminate construction 50 thus enables the use of a desired embossing layer thickness while achieving an overall lower weight and/or a thicker embossing layer. The laminate will thus provide and maintain the desired aesthetic qualities, while meeting weight requirements and significantly improve flammability characteristics.

Decorative laminates are also used in other components of an aerospace or other commercial transportation cabin interiors. For example, non-textile flooring (NTF) may be formed as a lightweight laminate construction to provide the required flammability characteristics as well as to enhanced appearance and durability. Such laminates may be custom configured with advantages for specific applications, including use in entryways, galleys, aisles, and lavatories for example. For each application, the laminate needs to meet applicable flammability, durability, and friction requirements.

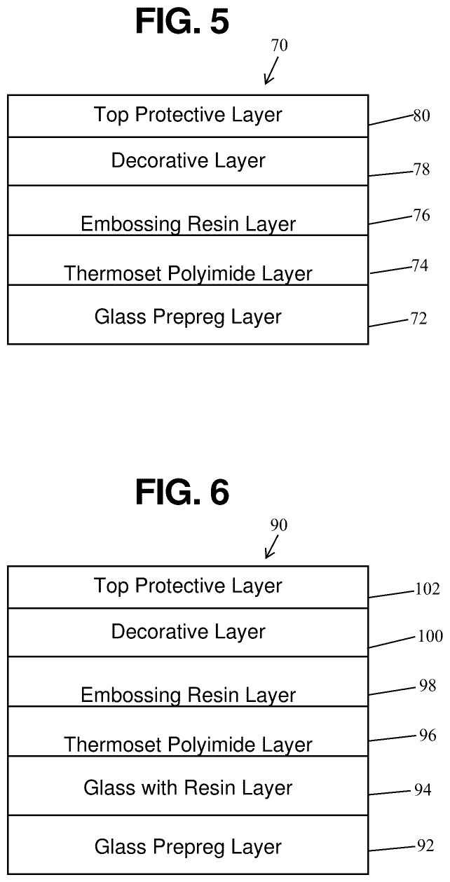

In FIG. 5, an example of a non-textile flooring (NTF) laminate 70 is shown. Non-textile flooring materials are commonly used to cover the floors of the cabin, cockpit, cargo areas and the like. These materials provide an aesthetically pleasing, durable and slip-resistant surface for passengers and crew to walk on, while also contributing to safety. The laminate of the invention allows for use as non-textile flooring materials and allow for tailoring to provide desired properties that make it suitable for specific applications and requirements. The non-textile flooring materials play an essential role in ensuring the safety and comfort of passengers and crew and contribute to the overall design and aesthetic of the aircraft or the like. The laminates for use in NTF applications use the thermoset polyimide layer optimized for dimensional stability. The NTF laminate 70 is designed to be durable and resistant to wear and tear. The laminate 70 can withstand heavy foot traffic and exposure to cleaning chemicals and other substances, making them ideal for use in aerospace and the like. The laminate 70 provides a slip-resistant surface that facilitates preventing accidents and injuries. The laminate 70 will also help to reduce noise levels and provide a stable and comfortable surface for passengers and crew to walk on, while being highly resistant to scuffs, scratches, and stains. The laminate 70 also provides a NTF that is extremely lightweight, which helps to reduce the overall weight of the aircraft or the like. This, in turn, can lead to fuel savings and lower operating costs. The laminate 70 includes a base layer 72 of a glass reinforced prepreg, formed using polyurethane (PU), polyethylene terephthalate (PET), epoxy or phenolic resins for example. The base layer 72 provides desired structural integrity for use as a flooring or like surface, with high tensile strength and dimensional stability. The laminate 70 may be configured to be applied to a floor surface using a layer of adhesive. For a high modulus material such as a glass reinforced prepreg, a high modulus adhesive may be used, such as a thermosetting adhesive, a thermoplastic adhesive or a UV or electron-beam curable adhesive for example. Alternatively, a pressure sensitive or other adhesive may be used, to allow repositioning of the material for example. A layer of thermoset polyimide resin or film 74 with a predetermined thickness is provided adjacent the prepreg layer 72. In this example, the thermoset polyimide film 74 has a predetermined thickness, such as between 0.5 to 10.0 mils (0.0127 to 0.254 mm). On the thermoset polyimide layer 74, an embossing resin layer 76 is provided, with a thickness of between 1.0 to 20.0 mils (0.0254 to 0.508 mm), but thicknesses can range up to 60.0 mils (1.524 mm) for example. The embossing resin layer may be formed of polyvinyl chloride (PVC), vinyl acetate (VA), polycarbonate (PC), acrylonitrile butadiene styrene (ABS), polyurethane (PU), polyetheretherketone (PEEK), polyphenylene sulfide (PPS), polyetherimide (PEI) or polyamide (PA) for example. A decorative ink layer 78 is provided adjacent the embossing resin layer 76, with a thickness of 0.01 to 2.0 mil (0.000254 to 0.0508 mm) for example. A top protective thermoplastic layer 80 having a thickness of about between 0.5 to 30.0 mils (0.0127 to 0.762 mm) may be formed of polyvinyl fluoride (PVF), polyvinylidene fluoride (PVDF), thermoplastic polyurethane (TPU), polyvinyl chloride (PVC), ethylene tetrafluoroethylene (ETFE), polytetrafluoroethylene (PTFE), polyethylene (PE), perfluoroalkoxy alkane (PFA) or polycarbonate (PC) for example. The protective layer 80 provides desired impact resistance, cleanability and other characteristics in combination with the laminate 70. The decorative ink layer 78 may be printed or otherwise applied on the back of the protective layer 80, with color or design visible through protective layer 80. The laminate 70 may be designed to be formable along with a surface or substrate on which it is applied. In this example, the laminate 70 provides a combination of various thicknesses of thermoplastic materials along with at least one thermoset polyimide layer to produce decorative laminate 70 useful for NTF applications for example. In such laminates used for flooring in aerospace passenger cabins or the like, the use of a thermoset polyimide 74 of a predetermined thickness (ranging from 0.5 to 10.0 mils for example) in combination with the other layers enhances flammability resistance of the overall construction. The provision of thermoset polyimide film layer 74 in the construction allows desired characteristics such as high tensile strength to be achieved while possibly reducing the thickness of base prepreg layer 72, and therefore the weight of the laminate. A thicker layer of thermoset polyimide 74 may thus be used to reduce the thickness of a reinforcing layer such as base prepreg layer 72. For non-textile flooring laminates, the embossing layer 76 thicknesses can range between 2.0 to 60.0 mils for example, again allowing use of a thicker embossing layer 76 for aesthetic purposes. The provision of the thermoset polyimide layer 74 again allows for a thicker embossing layer 76 while attaining a lower overall weight, due to its lower density. This in turn allows for a desired thickness of the embossing layer while not compromising the flammability characteristics nor weight.

In FIG. 6, another example of a non-textile flooring (NTF) laminate 90 is shown. The NTF laminate 90 is designed to be durable and resistant to wear and tear, and again provides a slip-resistant surface that facilitates preventing accidents and injuries. The laminate 90 also provides a NTF that is extremely lightweight. The laminate 90 includes a base layer 92 of a glass reinforced prepreg having a thickness between 5.0 to 20.0 mils for example. The prepreg 92 may be formed using polyurethane (PU), polyethylene terephthalate (PET), epoxy or phenolic resins for example. The base layer 92 provides desired structural integrity for use as a flooring or like surface, with high tensile strength and dimensional stability. The laminate 90 may be configured to be applied to a floor surface using a layer of adhesive. A layer of glass with resin 94, such as formed using PET, PVC, PC, PU, PEI or ECTF, is adjacent the prepreg base layer 92. The thickness of layer 94 is between 1.0 to 20.0 mils for example. A thermoset polyimide film layer 96 with a predetermined thickness is provided adjacent the layer 94. In this example, the thermoset polyimide resin or film 96 has thickness of between 0.5 to 10.0 mils. On the thermoset polyimide layer 96, an embossing resin layer 98 is provided, with a thickness of between 1.0 to 20.0 mils, but thicknesses can range up to 60.0 mils for example. In an example, a well performing laminate allowing desired visual features by embossing may use an embossing resin layer having a thickness of between 1.5 mils up to 8.0 mils (0.0381 to 0.2032 mm). The embossing resin layer may be formed of polyvinyl chloride (PVC), vinyl acetate (VA), polycarbonate (PC), acrylonitrile butadiene styrene (ABS), polyurethane (PU), polyetheretherketone (PEEK), polyphenylene sulfide (PPS), polyetherimide (PEI) or polyamide (PA) for example. A decorative ink layer 100 is provided adjacent the embossing resin layer 98, with a thickness of 0.01 to 2.0 mil (0.000254 to 0.0508 mm) for example. A top protective thermoplastic layer 102 having a thickness of about between 1.0 to 30.0 mils may be formed of polyvinyl fluoride (PVF), polyvinylidene fluoride (PVDF), thermoplastic polyurethane (TPU), polyvinyl chloride (PVC), ethylene tetrafluoroethylene (ETFE), polytetrafluoroethylene (PTFE), polyethylene (PE), perfluoroalkoxy alkane (PFA) or polycarbonate (PC) for example. In this example, the laminate 90 provides a combination of various thicknesses of thermoplastic materials to produce decorative laminate 90 useful for flooring applications for example. In NTF laminate for flooring in aerospace or the like, the use of a thermoset polyimide layer 96 of a predetermined thickness (ranging from 0.5 to 10.0 mils for example) in combination with the other layers enhances flammability resistance of the overall construction. The provision of thermoset polyimide film layer 96 in the construction allows desired characteristics such as high tensile strength to be achieved while possibly reducing the thickness of reinforcing materials such as base prepreg layer 92 and/or glass with resin layer 94, to reduce the thickness and weight of the laminate.

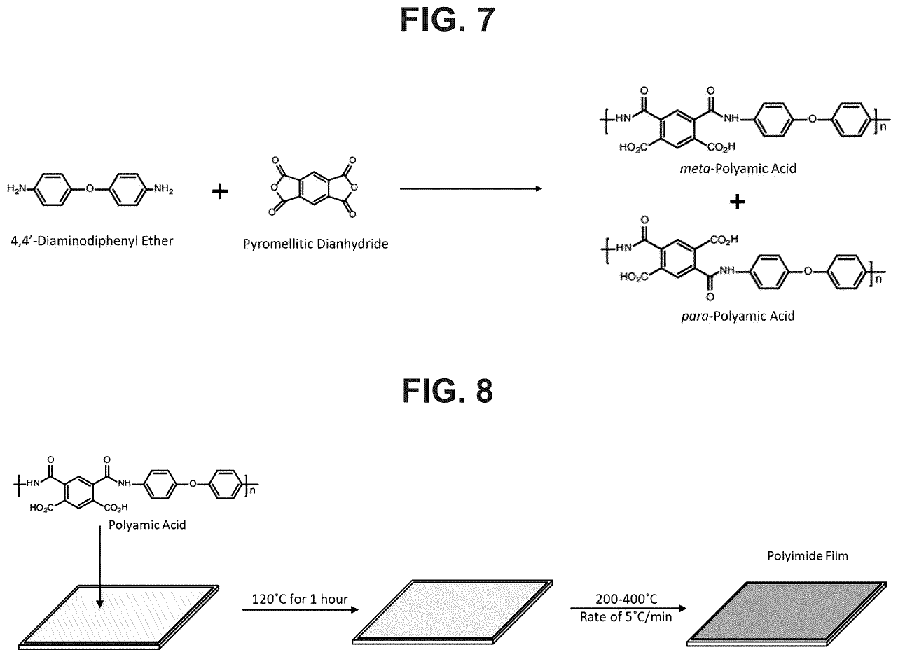

The laminates of the above examples provide a construction that enhances the flame retardancy by incorporating predetermined thicknesses and types of thermoset polyimide films. The thermoset polyimide film employed in the practice of this invention is a polyimide film prepared by reaction of an aromatic dianhydride or ester derivative and an aromatic diamine for example, wherein at least 70% to 100% of the hydrocarbon linkages of the base polymer contribute to an aromatic moiety. An “aromatic diamine” is intended to mean a diamine having at least one aromatic ring, either alone (i.e., a substituted or unsubstituted, functionalized or unfunctionalized benzene or similar-type aromatic ring) or connected to another (aromatic or aliphatic) ring, and such an amine is to be deemed aromatic, regardless of any non-aromatic moieties that might also be a component of the diamine. Similarly, the dianhydride as used herein is intended to mean the component that reacts with the diamine and in combination can react to form an intermediate polyamic acid, which is then cured into a thermoset polyimide. For example, the thermoset polyimide films are manufactured by dissolving synthesized polyimide resin, along with a compatible solvent such as N-methyl-2-pyrrolidone, to form a solution. The solids level of the solution determines the film thickness, which can then be cast or extruded onto a release substrate to obtain a continuous film. Films are produced through a precise and controlled manufacturing process that involves the synthesis of polyimide polymer, film formation, and post-processing. The process begins with the synthesis of polyimide by reacting aromatic dianhydride, such as pyromellitic dianhydride (PMDA), with an aromatic diamine, such as 4,4′-diaminodiphenyl ether (ODA) as shown in FIG. 7. This polymerization reaction takes place in a solvent, such as N-methyl-2-pyrrolidone (NMP), at elevated temperatures and under inert gas atmosphere to form a meta-polyamic acid and/or para-polyamic acid intermediate as in FIG. 7. The next step is the film formation process, where the polyamic acid is converted into a solid polyimide film. This conversion is achieved through a thermal curing process referred to as imidization. The polyamic acid film is heated gradually in a controlled manner, typically at temperatures ranging from 200° C. to 400° C., to facilitate the imidization reaction. During this process, the polyamic acid undergoes a series of chemical transformations, forming imide linkages and crosslinking the polymer chains to create a stable and robust thermoset polyimide film structure as shown in FIG. 8. Following the film formation, post-processing steps are performed to further enhance the film's properties. These steps may include thermal annealing at specific temperatures and durations to optimize the film's mechanical or other properties, as well as surface treatments like plasma treatment or chemical etching to modify the film's surface characteristics for improved adhesion or functionalization. Several companies produce thermoset polyimide-based films with different grades for various applications. For example, DuPont offers the Kapton® brand, including grades like Kapton® HN, Kapton® FN, Kapton® MT, and Kapton® XC, which possess specific properties such as thermal stability, electrical insulation, and mechanical strength. Kaneka Corporation manufactures polyimide films under the Apical® brand, which includes Apical® APA, Apical® FCR, and Apical® EX, known for their thermal resistance, electrical insulation, and dimensional stability. Saint-Gobain produces Norton® TH and Norton® PPL films, recognized for their thermal and electrical insulation properties. UBE Industries offers the UBE POLYIMIDE® brand, featuring the 2000 series, 5000 series, and 7000 series of polyimide films designed to meet specific requirements like thermal and chemical resistance. Toray Industries manufactures UPILEX® films, including the R, S, and F series, known for their mechanical strength, thermal stability, and chemical resistance. These types of thermoset polyimide films may be used in certain formable laminates for the aerospace interiors or like interiors as set forth in the examples above. The thermoset polyimide film layer(s) of the laminate together with the other noted thermoplastic layers provide excellent fire resistance, vapor barrier characteristics, while allowing formability and desired embossing. The laminate has a high tensile strength over a wide temperature range and dimensional stability provided by the thermoset polyimide, as well as wear resistance and chemical resistance in combination with the other layers.

Thermoset grades of polyimide materials are used as opposed to additional thermoplastic layers such as polyvinyl chloride (PVC), polyvinyl fluoride (PVF), polyvinylidene fluoride (PVDF), thermoplastic polyurethane (TPU), ethylene tetrafluoroethylene (ETFE), polytetrafluoroethylene (PTFE), polyethylene (PE), perfluoroalkoxy alkane (PFA) or polycarbonate (PC) for example. Thermoset polyimide is also used in the laminate construction and not other materials such as polyetherimide, such as Ultem® grades sold by Sabic. Polyetherimide (PEI) manufacturing is different because a dianhydride, like 4,4′-methylenedianiline dianhydride (MDA) reacts with a diamine like 4,4′-diaminodiphenyl ether (DDE) to polymerize into long chains of PEI molecules that can then be formed into a powder or pellets. These pellets can then be melted down in an extruder to form a thin film, typically in the range of 340° C. to 370° C. (644° F. to 698° F.). As opposed to polyetherimides, the thermoset polyimide in the laminates of the invention do not melt and have thermal decomposition temperatures in the range of 500° C. to 600° C. (932° F. to 1112° F.), and no glass transition temperature.

In the laminate constructions, the use of at least one thermoset polyimide layer with a predetermined thickness provides a much greater reduction in flammability in the resulting laminate, noted as being at least about a 15-30% reduction in flammability as opposed to previous commercial decorative laminates. The laminates of the invention is optimizable to achieve desired flammability performance, depending on the thickness of the thermoset polyimide layer in the laminate construction. The very high thermal decomposition temperature of thermoset polyimide film makes it much more suitable as a flame-retardant material over polyetherimide (PEI) or other thermoplastic materials. Thermoset grades of polyimide films are not used in thermoforming or formable laminate applications due to their thermosetting properties, but the laminate constructions of the invention allow use of the thermoset polyimide while still being formable using thermoforming techniques such as vacuum and pressure forming. For example, suitable forming methods can include, but are not limited to, mechanical forming (e.g., matched tool forming), membrane assisted pressure/vacuum forming, membrane assisted pressure/vacuum forming with a plug assist, and the like. In thermoforming, going higher in temperature may facilitate forming of the thermoset polyimide, but may also degrade thermoplastics like PVC and cause others to undesirably melt. If desired, other thermoplastic layers in the laminate may include heat stabilizers. These stabilizers slow down the degradation at elevated thermoforming and heating cycles in lower temperature thermoformable thermoplastics, such as PVC, ensuring the thermoplastic substrates do not yellow or break down. Examples of effective stabilizers include organotin stabilizers like methyl tin mercaptides, lead stearate, lead phosphate, calcium zinc stearates, organophosphites, phosphates, and ester stabilizers like epoxidized linseed oil, and barium or cadmium-based metal soaps. These stabilizers may be added in the range of 0.1% to 10% by weight to the PVC or PVC copolymer-based thermoplastic resin for example, with a similar range for other types of thermoplastic materials.

The at least one layer of thermoset polyimide film is polymerized to a sufficient viscosity and cured to a sufficient degree to provide the following properties: A) no melting point (ASTM Method E-794); B) no glass transition temperature (second order transition only above 700° F. DSC, TMA); C) shrinkage of between 0.10-0.20 (IPC TM 650, Method 2.2.4A); D) tensile modulus from 400 to 280 kpsi (ASTM D-882) and E) ultimate elongation 25%-70% (ASTM D-882). The thermoset polyimide film retains its physical properties over a wide temperature range.

The laminate with the at least one layer of thermoset polyimide provides significantly improved flammability characteristics. The OSU Ohio State University (OSU) heat release rate standard is a standard flammability test required by the FAA, EASA, Boeing, Airbus, and Chinese Airlines for example, and used to assess the flammability characteristics and fire behavior of materials, specifically those intended for use in aerospace and transportation applications. The FAA standards surrounding this test method are typically adopted by the other entities and have very minimal method variations, typically just to help improve testing variability. This test provides information about the heat release rate and total heat release of a material when exposed to a controlled heat source. The compliance requirements for aircraft interior compartment components are captured under FAR 25.853, which details requirements for specific testing outlined in the fire test handbook from the FAA. The OSU Ohio State University (OSU) heat release rate apparatus employs a modified (ASTM E906) standard. It has three (3) main sections: (A) a holding chamber which is a holding area prior to testing in which an injection mechanism slides through an outer door which is sealed and hinged; (B) an environmental chamber which contains radiant heating elements or panel, a reflector plate and diamond shaped mask with upper and lower pilot burners, air distributor plates (2), cold zone thermocouples (thermopile), two-part hinged insulated radiation door assembly with heat resistant viewing window; and (C) a pyramidal section which contains a chimney or exhaust stack with a cooling manifold which releases constant temperature air between two inner and outer cone sections, a baffle plate and a chimney (with hot zone thermocouples) to facilitate mixing of air as it exits the chimney. In evaluation of the flammability characteristics, the OSU rate of heat release test is typically the most difficult requirement to pass for aircraft interior components. In almost all cases, any material that passes the OSU rate of heat release test will also pass horizontal and vertical flame testing. In the OSU test, the specialized apparatus is designed to simulate realistic fire scenarios. The test specimen, typically a small sample of the material (6″×6″) being evaluated, is positioned vertically, and exposed to a specified heat flux using a radiant panel (e.g., globars). The heat flux represents the amount of heat energy that is transferred to the material's surface per unit area per unit time. During the test, the specimen is subjected to a predetermined heat flux (3.5 W/cm²) while measurements are taken to record the heat release rate and total heat release. The heat release rate is the amount of heat released by the material per unit of time, usually expressed in kW/m². The total heat release is the cumulative amount of heat released throughout the duration of the test and is generally reported in kW·min/m².

To assess the flammability performance, various parameters are measured, including the peak heat release rate, time to peak heat release, and the overall heat release throughout the test duration. These parameters provide insights into the material's ability to resist flame spread and its contribution to fire growth. The laminate according to various examples as described above were evaluated using the OSU test. The OSU heat release test was employed to demonstrate the effectiveness of incorporating the at least one thermoset polyimide film layer in the laminate construction in combination with other thermoplastic and embossing resin layers as described. In testing of such laminates for aerospace interiors using the required OSU test conditions for such laminates, there is always a requirement for testing a laminate on a phenolic composite standard. This composite standard emulates the typical material used to form the sidewall panels of an aircraft for example. All laminates are placed onto this composite and burned, and even though the composite also contributes to the overall peak and heat release values of the test result this is used as a standard for qualification of airworthiness. These composite phenolic panels, used as a test standard core are selected as the primary standard core material due to their properties, including high fire resistance, mechanical strength, and durability. The panel design in an aircraft is determined based on the specific requirements of the aircraft, considering factors such as size, shape, and structural reinforcement. Design specifications for the phenolic composite standard to be used in OSU testing may be set forth and the panel constructed to ensure compliance with regulatory standards and optimal performance. In the below examples, the type of phenolic composite panel used for the OSU heat release testing is called Type S and is a hexagonal configuration using Cormaster C1-3,2 48. It has a compressive strength of 1.8 MPa (bare) and 2.1 MPa (stabilized) as the interior layer along with 2 prepregs on the front and back of the honeycomb panel using PF808, which is a phenol resol system.

There can be substantial variability in these certified test composite panels, despite their careful manufacturing process, along with the existing variability in the OSU heat release test itself. A typical 6″×6″ Type S composite standard panel burned without a laminate on the face of the panel will typically range in total heat release values of 30 to 45 kW·min/m² (average standard deviation of 6 points), along with a peak heat release range of 35 to 45 kW/m². In the laminate of the invention, the at least one layer of thermoset polyimide is placed on the back or interior of the laminate to also hinder the inherent flammability of the phenolic standard test panel, and not just reduce the flammability of the laminate being applied to the composite standard. The combination of the laminate with a composite panel thus provides significantly enhanced flammability performance. As the laminate may be applied to a similar substrate for many applications in aircraft or other commercial transportation vehicles, this provides significant advantage. As will be noted in the examples, the 8-point decrease in the OSU heat release value signifies a significant improvement in flame retardancy, indicating a reduced heat release and decreased risk of fire spread in the tested laminates in combination with the substrate.

### Example 1

A series of laminate examples were prepared in accordance with various examples of laminate constructions with and without at least one layer of thermoset polyimide as in the laminates of the invention. Initial tests were conducted on decorative laminates not having at least one layer of thermoset polyimide and laminates having the at least one layer of thermoset polyimide. The decorative laminates not having at least one layer of thermoset polyimide included a top layer of PVF (1.0 mil, 0.0254 mm), a layer of embossing resin (PVC based (4.0 mil)), and a backing layer of: 1) PVF (1.0 mil, 0.0254 mm), 2) polyetherimide (PEI) (1.0 mil, 0.0254 mm) and 3) flame retardant PVF (Tedlar® FR250 (0.5 mil, 0.0127 mm). The laminates having the at least one layer of thermoset polyimide included a top layer of PVF (1.0 mil, 0.0254 mm), a layer of embossing resin (4.0 mil), and a backing layer of thermoset polyimide of thicknesses of 1.0 mil (0.0254 mm), 2.0 mil (0.0508 mm), 4.0 mil (0.1016 mm) and 5.0 mil (0.127 mm). In the following testing, the construction consisting of a 4.0 mil (0.1016 mm) PVC based embossing layer along with 1.0 mil (0.0254 mm) of PVF on the top and bottom was used as the standard to compare to the laminate of the invention. The construction without the at least one layer of thermoset polyimide produces borderline flammability results for products that have a specification requirement of 55 kW/m² for peak heat release and 55 kW·min/m² for total heat release. Such requirements are found as a specification for Airbus related flammability testing for example. The Federal Aviation Administration (FAA) in the United States and the European Union Aviation Safety Agency (EASA) typically recommend a specification of 65 kW/m² for peak heat release and 65 kW·min/m² for total heat release for airworthiness. In addition to the 6.0, 7.0 or 8.0 mil (0.1524, 0.1778, or 0.2032 mm) constructions of the sample laminates, a layer of 3.0 mils (0.0762 mm) of pressure sensitive adhesive was applied to the back of the laminate to adhere the sample directly to the phenolic type S panel for OSU testing. In addition to the laminates of the invention with 1.0 mil (0.0254 mm), 2.0 mil (0.0508 mm), 4.0 mil (0.1016 mm) and 5.0 mil (0.127 mm) thermoset polyimide film layers, a 1.0 mil (0.0254 mm) PEI and 0.5 mil (0.0127 mm) flame retardant PVF (Tedlar® FR250) was also tested for comparison. The test laminates also utilized an acrylic based ink in a decorative layer, as may be found in decorative laminates used in aerospace or other commercial transportation. The use of acrylic based ink generally results in a higher flammability and provides a worst-case scenario for meeting the OSU requirements for comparison.

The OSU test was conducted on these laminate samples, with the comparative results in Table 1 below.

TABLE 1

| | | Standard | | 1 mil PVF | 1 mil PVF | 1 mil PVF |
|---|---|---|---|---|---|---|
| | | 1 mil PVF | 1 mil PVF | 4 mil | 4 mil | 4 mil |
| | | 4 mil | 4 mil | 0.5 mil Tedlar | 1 mil | 2 mil |
| | | 1 mil PVF | 1 mil PEI | FR250 | Polyimide | Polyimide |
| Max Heat Release rate | kW/m2 | 53.4 | 46.5 | 48.4 | 47.4 | 43.6 |
| within 5 minutes (peak) - | | | | | | |
| PSA (kW/m2) | | | | | | |
| Heat Release within 2 | kW · min/m2 | 58.0 | 52.8 | 52.6 | 49.0 | 42.0 |
| minutes (total) | | | | | | |

| | | | | |
|---|---|---|---|---|
| Peak (kW/m2) - Reduction from Standard | −9% | −9% | −11% | −18% |
| Total (kW · min/m2) - Reduction from Standard | −9% | −9% | −16% | −28% |

As seen in Table 1, the laminate using PVF based film resulted in a relatively high OSU heat release values, having a peak heat release value of 53.4, and total heat release value of 58.0, indicating a higher propensity for flame spread. The laminate using a PEI base layer resulted in improved but still relatively high OSU heat release values, having a peak heat release value of 48.5, and total heat release value of 52.8. The laminate using a Tedlar® back layer resulted in improved but still relatively high OSU heat release values like the PEI back layer, having a peak heat release value of 48.4, and total heat release value of 52.6.

Significant improved performance was exhibited when the 1.0 mil (0.0254 mm) thermoset polyimide film was added to the back of the laminate, the OSU heat release value decreased by 9 points on average (a reduction of 16% in the total heat release and an 11% reduction in the peak heat release), with a peak heat release value of 47.4, and total heat release value of 49.0. Also, when 2.0 mil (0.0508 mm) layer of thermoset polyimide film was used in place of the 1.0 mil (0.0254 mm) thermoset polyimide film there was an even greater reduction by 16 points (−28% reduction in total heat release and an 18% reduction in peak heat release), with a peak heat release value of 43.6, and total heat release value of 42.0. An even more significant improvement was noted when a 4.0 mil (0.1016 mm) layer of thermoset polyimide film was used, where a peak heat release value of 31.5, and total heat release value of 42.6 was realized. With a 5.0 mil (0.127 mm) layer of thermoset polyimide film, an even better peak heat release value of 29.2, and total heat release value of 38.8 was realized. The significant improvement in performance using a thicker back layer of thermoset polyimide is very unusual because typically adding mass, even mass that is resistant to flame propagation, usually results in a slight increase in flammability not a further reduction. For example, the invention allows use of a back layer of thermoset polyimide with a thickness of 4.0 mils (0.1016 mm) of thermoset polyimide on the back of the construction to achieve the physical property requirements of the commercially available AerTrim® laminates, being a lightweight or medium-weight, glass fiber-reinforced decorative laminate for use in areas where increased abuse is expected. This may be accomplished without the glass fiber-reinforcement used in the commercially available AerTrim® laminates. The prior use of fiber-reinforcement in the commercially available AerTrim® laminates substantially hindered formability of the laminate, while use of a thickness of 4.0 mils (0.1016 mm) of thermoset polyimide on the back of the construction allows some formability. The test results confirm use of a predetermined thickness of thermoset polyimide on the back of the construction demonstrates the significant positive impact this material has in the laminate constructions and its ability to even reduce the inherit flammability of the standardized honeycomb composite test panel on which such laminates are tested and similar substrates that the laminates are applied to in the commercial transportation vehicle interior passenger compartments.

The measurement of smoke release according to the FAR 25.853, Appendix F, Parts IV and V is less than 200 as required for both laminate samples including the layer of thermoset polyimide film. The use of predetermined thickness thermoset polyimide film in the laminate provides significantly reduced peak and total heat release which would allow products that have a specification requirement of 55 kW/m² for peak heat release and 55 kW·min/m² for total heat release to comply with such requirements more easily.

### Example 2

Another study was conducted comparing the flammability between current commercial laminate constructions made and sold by Schneller, LLC, being AerFilm® laminates used to cover both flat and three-dimensional panels in aircraft interiors and AerTrim® laminates, being a lightweight or medium-weight, glass fiber-reinforced decorative laminate for use in areas where increased abuse is expected. The Aerfilm® LHR from Schneller, LLC is a low-heat-release, low-smoke and low-toxic-gas, engineered thin-film decorative laminate for covering flat and three-dimensional panels. It is relatively lightweight and economical and provides excellent impact and stain resistance. It has a typical areal density of 250 g/m². Typical tear strength is 1.49 N in the machine direction of lamination and 1.65 N in the transverse direction. The commercially available Aertrim® LW product from Schneller, LLC, is a low heat release, low smoke and low toxic gas decorative laminate that provides enhanced durability. The high stability and durability of this product is attributable to the fact that this product contains a glass reinforced backing layer. Therefore, this product can only maintain two-dimensional formability and is therefore used, for example, in relatively flat laminate panels. The glass reinforced backing layer also adds greater weight to the laminate. These commercial laminates were tested along with a laminate according to the invention in which a layer of PVF in the AerFilm® laminate was replaced with a thermoset polyimide layer having a 1.0 mil (0.0254 mm) thickness. A layer of 3.0 mils (0.0762 mm) of pressure sensitive adhesive was applied to the back of the laminates to adhere the samples directly to the phenolic type S panel for OSU testing. The results of OSU testing on these laminates are shown in Table 2.

TABLE 2

| | | | Standard | Standard | AerFilm With | % Improvement | % Improvement |
|---|---|---|---|---|---|---|---|
| | | | AerTrim | AerFilm | Polyimide | over AerFilm | over AerTrim |
| Heat release | kW/m² | AITM | 46.8 | 45.7 | 37.3 | −18.4% | −20.4% |
| Maximum heat rate | | 2-0006 | | | | | |
| within 5 min. (peak) (PSA) | | | | | | | |
| Heat release within 2 min. | kW · min/m² | | 52.8 | 56.4 | 37.4 | −33.7% | −29.2% |
| (total) (PSA) | | | | | | | |

As seen in the flammability test results, the AerFilm® laminate with a layer of thermoset polyimide in place of a layer of PVF had a ˜30% reduction in overall total heat release and ˜19% reduction in the peak heat release if averaged across both product families. This is significant since the woven glass used in the AerTrim® laminate typically provides additional flame resistance when compared to a standard laminate product using only thermoplastic layers like AerFilm®. The significant decrease in the OSU heat release value of the laminate including the at least one layer of thermoset polyimide results in a laminate that will effectively reduce the spread of flame and the amount of heat released during a fire event. This improvement in flame retardancy significantly enhances the safety of the laminates, making them more suitable for aerospace interior applications. Additionally, the at least one layer of thermoset polyimide with a predetermined thickness provides a laminate with high tensile strength and dimensional stability, to allow use in applications where the laminate has previously been glass fiber-reinforced, such as the AerTrim® laminate. This is achieved while reducing the thickness and weight of the laminate by eliminating the glass reinforced backing layer. The laminate of the invention may also have reduced thickness while still enabling proper texture and embossing retention in the final product.

In the laminate of the invention, the at least one layer of thermoset polyimide may also be combined with additional layers of flame retardants, such as in association with an optional adhesive layer. Generally, useful flame retardants include those that operate by forming a char layer across the surface when exposed to a flame. Other flame retardants include those that operate by releasing water upon thermal decomposition of the flame retardant compound. Useful flame retardants may also be categorized as halogenated flame retardants or non-halogenated flame retardants. For example, flame retardants like ATH (aluminum trihydrate), zinc borate, antimony-based flame retardants, phosphates, or even halogenated flame retardants within a laminate, though non-halogenated flame retardants may be preferred if additional reduction in flammability is required. In the laminate, the thermoset polyimide film serves as the heat resistant foundation of the laminate, providing mechanical strength and stability. The laminates possess enhanced flame retardant properties and can endure high temperatures without melting or dripping. The thermoset polyimide film acts as a base material and char layer, and when placed at or near the back of the laminate construction, it provides the foundation for the enhanced and improved fire protection capabilities of the entire laminate, particularly in association with a substrate as used in aircraft or like interiors.

To facilitate providing laminates with desired fire protection performance, other FR materials may be used as noted, such as ATH which when exposed to heat, undergoes a chemical reaction and releases water vapor. This water vapor acts to dilute and cool the surrounding gases, effectively reducing the temperature of the material and slowing down the combustion process. Additionally, ATH forms a protective layer on the surface, hindering further heat transfer. Zinc borate can work in tandem with ATH. When subjected to heat, it releases water vapor like ATH. However, it also functions as a char-forming agent. As heat is applied, zinc borate forms a protective char layer on the material's surface. This char layer acts as a barrier against heat and oxygen, also impeding the progression of combustion. The inclusion of antimony-based flame retardants may serve to enhance the fire resistance of the laminate, as such materials are known for their ability to release gases that suppress the combustion process, inhibiting the spread of flames and reducing the material's flammability. Phosphates may be used and acts as both flame retardant and smoke suppressant. Phosphates function by releasing gases that interrupt the combustion process, forming a protective layer on the material's surface. Additionally, phosphates work to minimize the amount of smoke generated during a fire, improving visibility, and reducing potential hazards. If needed, halogenated flame retardants, which contain elements such as bromine or chlorine, may enhance the fire resistance of the laminate by interfering with the combustion process by releasing halogen radicals when exposed to heat. These radicals chemically disrupt the formation of flammable gases and slow down the combustion rate. If these or other flame retardants are used with the at least one thermoset polyimide layer, together they can contribute to various aspects of fire protection. Together for example, the overall fire resistance and flame retardancy of the decorative laminate can be tailored for the application, ensuring a safer environment in the presence of potential fire hazards. The at least one layer of thermoset polyimide forms a char layer that will reduce the chance of the material underneath is exposed to oxygen and heat. The formation of a good protective char layer earlier in the burning process improves the heat release performance of the laminates in this invention. The laminate will resist burning through based on the tendency of the thermoset polyimide to form an insulating char layer between the fuel layer or substrate and the source of ignition.

The laminates of the invention also provide significant weight reduction while achieving the desired tensile strength and dimensional stability characteristics. The densities of industry standard flame retardants are typically very high and can vary. Below are approximate density ranges for several commonly used flame retardants used in laminates: Aluminum trihydrate (ATH) has a density of around 2.4 g/cm³, while antimony trioxide (ATO) has a density of approximately 5.2 g/cm³. Zinc borate's density ranges from 2.4 to 3.4 g/cm³, and magnesium hydroxide has a density of about 2.4 g/cm³. The thermoset polyimide in the laminate construction of the invention has a density range of 1.3 to 1.5 g/cm³. For example, if a 1.0 mil (0.0254 mm) layer of thermoset polyimide is used instead of a bottom 1.0 mil (0.0254 mm) flame retarded PVF film in the commercial AerFilm® laminate construction, there is a theoretical weight reduction potential of 20.45%. This is due to the lower density of the thermoset polyimide being around 1.4 g/cm³ and PVF being 1.76 g/cm³. The theoretical weight reduction comparison between a PVF layer and a thermoset polyimide layer in association with a 3.0 mil (0.0762 mm) FR layer with mid FR loading is shown below in Table 3.

TABLE 3

| | Mid with PVF | Mid with PI |
|---|---|---|
| | grams | grams |
| PVFFilm | 0.0894 | 0.0447 |
| 3 mil FR Layer Low FR Loading | | |
| 3 mil FR Layer Mid FR Loading | 0.1329 | 0.1329 |
| 3 mil FR Layer High FR Loading | | |
| 1 mil PI | | 0.036 |
| Total | 0.222 | 0.178 |

| | |
|---|---|
| Total Laminate Weight Reduction | −20.1% |

In a sample laminate, it was determined that using the thermoset polyimide layer at a 1.0 mil (0.0254 mm) nominal thickness instead of a 1.0 mil (0.0254 mm) layer of PVF in an AerFilm® laminate reduced the weight of the laminate by ˜12%, as noted in Table 4 below. Though below the theoretical weight reduction, perhaps due to variables like slight gauge variations within other layers of the laminate samples, it still represented a significant reduction. The results clearly demonstrate the significantly lowered construction weight when introducing the at least one thermoset polyimide layer having a similar thickness to the PVF layer in the commercial AerFilm® construction.

TABLE 4

| | | | | Standard | Standard | AerFilm With | % Improvement | % Improvement |
|---|---|---|---|---|---|---|---|---|
| | | | | AerTrim | AerFilm | Polyimide | over AerFilm | over AerTrim |
| Weight per | g/m2 | ISO 3801 | <300 g/m2 (AerFilm) | 547 | 285 | 251 | −11.9% | −54.1% |
| unit area | | method 5 | <580 g/m2 (AerTrim) | | | | | |

As also tested, the use of the thermoset polyimide layer may eliminate the need for glass reinforcement as used in the commercial AerTrim® product, and results in a weight reduction of over 54%, while providing high tensile strength and dimensional stability.

The at least one thermoset polyimide layer can be used to further reduce the weight of the laminate by eliminating the need for FR materials in the laminate. For example, a 3.0 mil (0.0762 mm) flame retardant adhesive formulation is a typical thickness used in the commercial AerFilm® laminate construction. In Table 5 below, some of the typical flame retardants were added in equal proportions at low, medium, and high loading levels. It was determined that due to the reduction in OSU heat release values resulting from the at least one thermoset polyimide layer, there can be a corresponding reduction or even elimination of the use of flame retardants in the laminate construction. The flame-retardant packages were made equivalent to give an average density at the different loading levels, this generalizes the overall comparison of the reduction. In Table 5 there are six laminate samples, two with low levels of flame retardants, two with medium levels of flame retardants, and two with high levels of flame retardants. For each loading level, a sample including a layer of thermoset polyimide was introduced into the construction and required even lower flame retardants levels, due to the flame retardant benefits of the thermoset polyimide layer on the overall construction.

TABLE 5

| | | Non-PI Film Constructions | | | For Use with PI Film | | |
|---|---|---|---|---|---|---|---|
| | Density | Low FR | Mid FR | High FR | Low FR | Mid FR | High FR |
| | g/cm3 | wt % | wt % | wt % | wt % | wt % | wt % |
| Base Polymer Avg Density | 1.25 | 90 | 75 | 50 | 95 | 90 | 85 |
| ATH | 2.4 | 2.5 | 6.25 | 12.5 | 1.25 | 2.5 | 3.75 |
| ATO | 5.2 | 2.5 | 6.25 | 12.5 | 1.25 | 2.5 | 3.75 |
| Zinc Borate | 2.9 | 2.5 | 6.25 | 12.5 | 1.25 | 2.5 | 3.75 |
| Magnesium Hydroxide | 2.4 | 2.5 | 6.25 | 12.5 | 1.25 | 2.5 | 3.75 |

Samples were prepared with the different FR loading as set forth in Table 5, and the approximate grams in a 1 cm×1 cm×0.762 cm (3 mil) sample are shown in Table 6. There are the three samples using a 1.0 mil (0.0254 mm) PVF on the top and 1.0 mil (0.0254 mm) PVF on the bottom. These are compared to three samples on the right which have reduced flame retardant loadings and substitute the 1.0 mil (0.0254 mm) PVF for a 1.0 mil (0.0254 mm) PI film on the back of the laminate. The use of the layer of thermoset polyimide produces significant weight reductions in the laminate construction, by reducing FR loading requirements.

TABLE 6

| | Low with | Mid with | High with | Low with | Mid with | High with |
|---|---|---|---|---|---|---|
| | PVF | PVF | PVF | PI | PI | PI |
| | grams | grams | grams | grams | grams | grams |
| PVF Film | 0.0894 | 0.0894 | 0.0894 | 0.044704 | 0.044704 | 0.044704 |
| 3 mil FR Layer Low FR Loading | 0.1103 | | | 0.102775 | | |
| 3 mil FR Layer Mid FR Loading | | 0.1329 | | | 0.1103 | |
| 3 mil FR Layer High FR Loading | | | 0.1705 | | | 0.117824 |
| 1 mil PI | | | | 0.03556 | 0.03556 | 0.03556 |
| Total | 0.200 | 0.222 | 0.260 | 0.147 | 0.155 | 0.163 |

| | | | |
|---|---|---|---|
| Total Laminate Weight Reduction | −26% | −30% | −37% |

Note that the PVF constructions have 2 mils of PVF (top and btm). While the PI has 1 mil PVF on top and 1 mil PI on bottom.

Another possible approach to attempt to reduce weight is to reduce the thickness of the laminate layers which reduces the mass of material being measured during the OSU heat release test. But a reduction in the laminate thickness in already very thin film laminates using only thermoplastic material layers, will not have proper texture and embossing retention in the final product since there is a lack of material left over to impart a texture into. The use of the at least one layer of thermoset polyimide allows a thickness of embossing resin to be included to achieve the desired highly textured and embossed appearance. The at least one layer of thermoset polyimide also provides retention of textured and embossed appearance in the final product, while still reducing the weight of the laminate. A desired surface relief or texture is ordinarily imparted to the laminate by a hot press process. During the press cycle, the laminate's layer(s) of thermosetting emboss resin is “molded” by the texture media (i.e., the textured press). The emboss resin is said to be molded because shear flow occurs within the thermosetting resinous material resulting in the layer's cross-sectional thickness variation, i.e., the creation of an embossed or textured surface. The thickness of the emboss resin layer(s) must be sufficient to allow the desired amount of relief or texture to be imparted, and then to be retained in the laminate construction during manufacture and application to a substrate. The thermoset polyimide layer provides significant dimensional stability in the laminate and facilitates retention of the desired relief and texture provided by the emboss resin, by eliminating stretch or deformation during manufacture or use. The heat and length of a hot press cycle that may be used in forming the laminate raises the embossing layer's viscosity and counteracts the residual stresses of the thermoplastic film layers during embossing and does not adversely impact the dimensional stability of the thermoset polyimide layer. The at least one thermoset polyimide layer prevents possible stretching of the laminate during embossing or application, which could lead to loss of texture retention when the laminate when heated and vacuum formed onto a composite panel for example.

Higher laminate tensile strength also helps with dimensional stability. This is a required physical property for many aerospace or aviation interior laminates and NTF (Non-textile flooring). To provide required tensile strength and dimensional stability, a glass reinforced prepreg or glass filled resin layer is used for some applications. Another downside to using glass to increase dimensional stability is that the laminate product cannot be formed, particularly where deep draw or complex curved contours are required. This significantly reduces the applications where glass reinforced materials can be used since it can only be used on simple, flat, or low complexity geometries. Currently, this leaves the thermoplastic laminates as the only viable product for applications where significant forming is required. Current thermoplastic laminates do not provide significant dimensional stability and overall strength, which again may be a requirement for the application. The thermoset polyimide layer may also reduce or eliminate the need for a reinforcing material such as the laminate of the invention still allows some flexibility and elongation to conform to the shape of a substrate shape, but the at least one layer of thermoset polyimide film with high tensile strength and dimensional stability provides advantages. incorporation of the at least one thermoset polyimide layer provides high tensile strength that is still optimized for formability, enabling use in applications where significant formability is required, such as where deep draw or complex curved contours are required, but also providing high tensile strength and dimensional stability.

Interior laminate dimensional stability is typically evaluated using ASTM D1204, which is “Standard Test Method for Linear Dimensional Changes of Nonrigid Thermoplastic Sheeting or Film at Elevated Temperature”. The test is conducted at 75° C. for 24 hours, and at 95° C. for 1 hour. The dimensional stability is measured as % change=(final length-original length)/original length×100. In prior decorative laminates, a high strength and dimensionally stable product required incorporation of a woven glass layer in the construction. As noted, in the laminate of the invention, the at least one layer of thermoset polyimide has high tensile strength and very low elongation. This provides high dimensional stability during and after going through processing steps such as with web processing equipment. Again, this eliminates the need for a glass layer in the laminate construction, which will make it lighter weight. At the same time, the at least one thermoset polyimide layer is optimized to allow for some laminate stretching when exposed to vacuum forming and/or pressure forming or the like. The dimensional stability of the commercial AerTrim® and AerFilm® laminate products made and sold by Schneller, LLC were evaluated along with examples of the laminate of the invention, using a 1.0 mil (0.0254 mm) layer of thermoset polyimide in place of a 1.0 mil (0.0254 mm) layer of PVF in the AerFilm® construction, with the results shown in Table 7 below. It is noted that the AerTrim® laminate product has zero stretch due to the layer of woven glass used in its construction.

TABLE 7

| | | | Storage | | | Standard | Standard | AerFilm With | % Improvement |
|---|---|---|---|---|---|---|---|---|---|
| | | | tem. [° C.] | time [h] | Spec | AerTrim | AerFilm | Polyimide | over AerFilm |
| Dimensional | % | AIMS 04- | 75 | 24 | Long. 0/−1.5 | 0 | −1.29 | −0.53 | −58.8% |
| Stability | | 09-000 | | | Trans. +/−1.5 | 0 | −1.43 | −0.10 | −93.0% |
| | | para | 95 | 1 | Long. 0/−2.0 | 0 | −1.72 | −0.57 | −67.1% |
| | | 4.2.2.1.4 | | | Trans. +/−1.5 | 0 | −1.43 | 0 | −100.0% |

As seen in Table 7, the dimensional stability of the laminate with the 1.0 mil (0.0254 mm) layer of thermoset polyimide is significantly improved as compared to a laminate having only thermoplastic layers, and yet is optimized to allow an amount of stretch based on the specific thickness of the thermoset polyimide when used in combination with other thermoplastic layers. This creates enough resistance to stop stretching, but still allows a low enough resistance for vacuum forming. A 1.0 mil (0.0254 mm) thermoset polyimide shows the benefit of increasing the dimensional stability while allowing some amount of stretch, but other thicknesses may allow for increased dimensional stability for applications where this is required, such as NTF laminates for example.

Higher laminate tensile strength also helps with dimensional stability. This is many times a critical physical property for aerospace interior laminates and NTF (Non-textile flooring). To provide the desired tensile strength, prior laminate constructions using thermoplastic layers were combined with a woven glass layer that will not stretch. A downside to using glass to increase dimensional stability and tensile strength is that the product cannot then be formed. This significantly reduces the applications where the laminate can be used since it can only be used on simple, flat, or low complexity geometries. In applications where formability is required, prior thermoplastic laminates using only thermoplastic layers were then used, without a woven glass layer, to allow use in deep draw or complex contoured applications. However, prior thermoplastic laminates using only thermoplastic layers may not have required or desired dimensional stability and overall strength. In the laminates of the invention, the at least one layer of thermoset polyimide layer creates a laminate product that fills the gap between thermoplastic laminates and woven glass laminates, providing both formability and high dimensional stability and tensile strength.

The tensile strength of laminates of the invention was compared to current commercial laminate constructions, including thermoplastic laminates and woven glass laminates. Based on the results of testing detailed in Table 8, the laminate of the invention with a 1.0 mil (0.0254 mm) layer of thermoset polyimide replacing a 1.0 mil (0.0254 mm) layer of PVF in the thermoplastic AerFilm® laminate. It is noted that the woven glass laminate AerTrim® does not elongate due to the woven glass reinforcing layer. The laminate of the invention nearly doubled the tensile strength in direction of lamination in relation to the thermoplastic AerFilm® laminate. There was not a significant difference in the tear resistance, but if higher tear resistance is desired, the thickness of the at least one layer of thermoset polyimide or other embossing layers can be used, while still reducing the overall weight of the laminate in comparison to the AerTrim® laminate using a woven glass layer for example.

TABLE 8

| | | | | | Standard | Standard | AerFilm With | % Improvement |
|---|---|---|---|---|---|---|---|---|
| | | | | | AerTrim | AerFilm | Polyimide | over AerFilm |
| Tensile strength (MD) | N/15 mm | ISO 527-3/2/50 | 50 mm/min test speed | 70^{1) 2) 3)} | N/A | 71.48 | 141.05 | 97.3% |
| Tensile strength (CM) | N/15 mm | ISO 527-3/2/50 | 50 mm/min test speed | 70^{1) 2) 3)} | N/A | 81.076 | 154.87 | 91.0% |

The possible optimization of the laminate of the invention to provide desired tear resistance in addition to high tensile strength and dimensional stability is shown for example in a comparison of the commercial thermoplastic AerFilm® laminate with different thicknesses of thermoplastic backing layer to the use of the same thicknesses of a thermoset polyimide backing layer. It was determined that using the thermoset polyimide layer achieved significantly increased tear resistance, tensile strength and dimensional stability at increased thicknesses as compared to the thermoplastic laminate, even while decreasing the weight of the laminate substantially as compared to a heavier duty laminate using woven glass to achieve such characteristics for example, as noted in Table 9 below.

TABLE 9

| | | | | | | AerFilm With Polyimide Back Layers | | | |
|---|---|---|---|---|---|---|---|---|---|
| | | AerFilm With PVF Back Layers | | | | Sample 5 | Sample 6 | Sample 7 | Sample 8 |
| | | Sample 1 | Sample 2 | Sample 3 | Sample 4 | 1 mil PVF | 1 mil PVF | 1 mil PVF | 1 mil PVF |
| | | 1 mil PVF | 1 mil PVF | 1 mil PVF | 1 mil PVF | 4 mil PVC | 4 mil PVC | 4 mil PVC | 4 mil PVC |
| | | 4 mil PVC | 4 mil PVC | 4 mil PVC | 4 mil PVC | Resin | Resin | Resin | Resin |
| | | Resin | Resin | Resin | Resin | 1 mil | 2 mil | 3 mil | 4 mil |
| Test | | 1 mil PVF | 2 mil PVF | 3 mil PVF | 4 mil PVF | Polyimide | Polyimide | Polyimide | Polyimide |
| Weight per unit area | g/m2 | 253.12 | 297.33 | 346.93 | 392.95 | 241.25 | 279.6 | 315.82 | 354.56 |
| Tear resistance (MD) | N | 3.11 | 4.15 | 5.82 | 7.68 | 1.85 | 2.28 | 2.86 | 3.56 |
| Tear resistance (CM) | N | 3.24 | 4.33 | 6.01 | 7.66 | 2.19 | 2.44 | 2.9 | 3.53 |
| Tensile strength (MD) | N/15 mm | 75.74 | 97.37 | 112.99 | 129.89 | 123.462 | 218.81 | 317.616 | 397.138 |
| Tensile strength (CM) | N/15 mm | 80.36 | 99.25 | 116.12 | 133.52 | 133.66 | 226.108 | 322.746 | 420.77 |
| Dimensional stability | % MD | −1.13% | −0.93% | −0.80% | −0.99% | −0.40% | −0.13% | −0.07% | −0.27% |
| (24 hr @ 75 C.) | | | | | | | | | |
| Dimensional stability | % XD | −0.86% | −0.47% | −0.80% | −0.80% | −0.27% | −0.33% | −0.13% | −0.20% |
| (24 hr @ 75 C.) | | | | | | | | | |

In the compared samples of the AerFilm® laminate, laminates using given thickness a backing layer of PVF were compared to laminates using a backing layer of a thermoset polyimide. The thicknesses of the backing layers in the compared samples were 1.0 mil (0.0254 mm), 2.0 mil (0.0508 mm), 3.0 mil (0.0762 mm) and 4.0 mil (0.1016 mm) respectively. The laminate constructions with the backing layer included a 1.0 mil (0.0254 mm) top layer of PVF, a 4.0 mil (0.1016 mm) layer of PVC embossing resin on the backing layer. The tensile strength, tear resistance, weight and dimensional stability were compared as the backing layer thickness increases. The results of tear resistance from the additional layers of PVF in the backing layer showed an increase in the tear resistance, but not much increase in tensile strength. But, though having greater tear resistance, the constructions using additional layers of PVF beyond a 1.0 mil (0.0254 mm) layer, will not meet the requirements for heat release and toxicity as described above, making these constructions unsuitable. The addition of additional thickness of PVF results in the production of unacceptable levels of hydrogen fluoride (HF) and complex mixtures of other volatile products during pyrolysis for example. In contrast, as noted above, the additional thicknesses of thermoset polyimide will meet the requirements for heat release and toxicity, while providing significantly enhanced tear resistance, tensile strength and dimensional stability.

The dimensional stability comparison was run at an extended timeframe (24 hours) to get a larger comparison. As noted in Table 9, each sample of laminate using the thermoset polyimide layer of differing thicknesses achieved a dimensional stability that meets the tight dimensional requirements for such laminates in aerospace and like applications, especially when compared to the constructions using PVF as the backing layer, that shrink around −0.85% on average compared to the thermoset polyimide layer average of −0.23%. This percentage shrinkage difference makes a significant difference if the laminate is large, with decorative printing and textures applied over lengths of 100″ or more for example. With such laminates, the shrinkage of the thermoplastic laminate using PVF backing layer could mean the panel to which the laminate is applied being 1″ off as compared to ¼″ off for the laminate using the thermoset polyimide backing layer. The shrinkage of the thermoplastic laminate using the PVF backing layer can cause significant alignment and installation issues as compared to the laminate the thermoset polyimide backing layer.

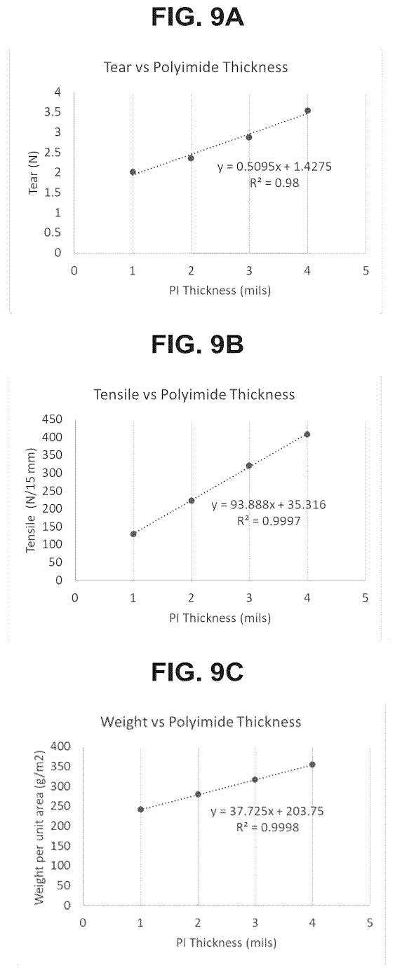

The ability to optimize the tensile strength, dimensional stability and tear resistance of the laminate is provided by adding thickness in the thermoset polyimide layer or providing additional layers of the thermoset polyimide in the laminate construction. This is possible without exceeding the required weight specification for the laminate. To give an estimate on potential performance at the top end of the weight specification, 580 g/m², the linear correlation functions of the physical properties versus polyimide thickness were used, as shown in FIGS. 9A-9C for tear resistance, tensile strength and dimensional stability respectively. As noted the linear correlation based on increased thickness of the thermoset polyimide layer, indicates that approximately 9.5 mils of thermoset polyimide can be used in the construction to yield a weight per area of 562 g/m², below the top end of the weight specification, 580 g/m². At this thickness, a tear strength of about 6.27 N could be realized, and a tensile strength of about 927 N/15 mm. This significantly increased tear strength and tensile strength is substantial, as it approaches the same properties of a laminate including woven glass, such as AerTrim®. This significantly enhanced performance is achieved while also achieving higher flame retardancy and formability than such heavy duty laminates including woven glass, such as the AerTrim® laminate. Alternatively, the laminate may use a thickness of thermoset polyimide to achieve desired tear strength and tensile strength while significantly reducing the weight of the laminate as compared to heavy duty laminates, for applications where increased wear would be expected but formability is required.

The provision of at least one layer of a thermoset polyimide layer in the laminate construction provides a tensile strength that also eliminates the need for a carrier in the laminating process. For thermoplastic films that are very thin, such as in the range of 0.25 to 1.0 mils in thickness, a high tensile strength carrier is required to prevent stretching in the laminating process. The carrier is needed to add support to the highly elastic polymer through the laminate production process and is then removed at a later step after the polymer film is applied to a substrate. Thermoplastic layers such as formed of polyvinyl chloride (PVC), polyvinyl fluoride (PVF) for example, exhibit significant elongation properties, and may require a carrier depending on the thickness. For example, PVC films are known for their flexibility and can typically stretch between 100% and 400%, while PVF films, such as Tedlar®, exhibit moderate elongation properties, ranging from 50% to 100%. In the laminate of the invention, the at least one layer of a thermoset polyimide film, which has lower elongation values ranging from 25% to 70%, may thus eliminate the need for a carrier in the laminating process. The ability to run a continuous web laminating process without a carrier during subsequent lamination steps results in operational efficiency by eliminating the need for an additional stripping step, usually performed after lamination. Though the at least one layer of thermoset polyimide avoids inadvertent stretching in the laminate construction, the lack of a carrier can impart a wavy appearance due to the lack of a carrier during the laminating process with other layers. In such event, using a high pressure and temperature embossing step to impart a texture will relax the material to get to a uniform and stable state to eliminate this appearance and normalize the overall state of the laminate.

In the laminates of the invention, it is also possible to use a high pressure and temperature embossing step after the lamination of the at least one layer of thermoset polyimide to impart a texture and relax the thermoset polyimide material to obtain a uniform and stable state, with a desired smoothness of the at least one layer of thermoset polyimide in the overall laminate construction. This will allow the embossing layer to form the desired textures or other dimensional characteristics without interference from any other layers in the laminate construction.

Regarding formability, examples of the laminate of the invention using the at least one layer of thermoset polyimide optimized to allow forming in deep draw or complex curve applications as may be desired. To evaluate formability, a dome mold thermoforming test was used, in which a sample of the laminate using 1.0 mil (0.0254 mm) and 2.0 mil (0.0508 mm) layer of thermoset polyimide in place of a 1.0 mil (0.0254 mm) layer of PVF in the AerFilm® thermoplastic laminate. The sample of laminate is placed over a concave mold with a shape resembling a dome. The laminate is heated and stretched and pressed over the mold using vacuum and/or pressure, allowing it to conform to the shape of the mold and create a three-dimensional structure. The purpose of this test is to assess the ability of the material to stretch, deform, and maintain dimensional stability during the thermoforming process. This test helps determine the formability, uniformity of thickness, surface finish, and the presence of any defects such as thinning, cracking, or excessive stretching of the material when exposed to thermoforming conditions. By analyzing the results of the dome mold thermoforming test, manufacturers can assess the suitability of a plastic material for specific applications and make informed decisions regarding process parameters, tooling design, and material selection. In the testing the laminate in this manner, its performance is characterized based on different heights stretch over the dome. The material height is measured up until it fractures or degrades beyond the requirements of the application. The typical failure mode is when the laminate breaks. For deep draw applications, stretching heights of up to 3.5 inches may be required. Typical conditions for this formability test are conducted between 70° C. to 200° C. Heating times can range from a few seconds to a few minutes, and cooling times can vary from a few seconds to several minutes. One important parameter in the dome mold test is the pressure applied. The pressure helps achieve proper material deformation and forming. While the specific pressure can vary depending on the laminate construction and desired outcome, a typical vacuum pressure of 4 in Hg (inches of Mercury) is often applied. This vacuum pressure aids in drawing the material onto the mold surface and shaping it according to the desired dome shape. From this testing, using the thermoforming temperatures between 70° C. to 200° C., a 3-3.5 inch draw was achieved for laminate of the invention with a 1.0 (0.0254 mm) mil and 2.0 mil (0.0508 mm) layer of thermoset polyimide, with the laminate having the desired weight per area range of 150 to 700 g/m². This demonstrates that a laminate according to the invention will provide high dimensional stability and tensile strength while allowing formability, even for deep draw applications which are commonly required in aerospace/aviation laminates. In other testing, a laminate of the invention using a 1.0 mil (0.0254 mm) layer of thermoset polyimide was evaluated using a deep draw thermoforming tool at a standard thermoforming temperature of 225° F. The results showed desired formability in the laminate construction, with the thermoset polyimide optimized to provide desired stretching when vacuum pressure from the thermoform is used. As the thermoset polyimide layer does not have a melting point nor typical glass transition temperature, the thermoforming temperature does not result in any melting or stretching. The desired deep draw form was achieved without tearing or disfiguration and providing uniform surfaces on the face and back of the laminate construction as desired in deep draw applications.

It is also a potential problem with thin aerospace laminates that the topology of the substrate that the laminate is being applied can show through, referred to as “telegraphing”. A common requirement for such laminates is therefore that the thin decorative laminate hide any surface imperfections on the substrate surface they are applied to. In some applications, this has required that the laminate be thicker to help hide this telegraphing effect. But increasing the thickness is often not possible due to the flammability and other strict requirements for the laminate. In the laminate of the invention, though being formable, the at least one thermoset polyimide layer in the construction also serves to mitigate possible telegraphing since it is more difficult to form into small or narrow contours. This particularly useful when forming sidewall panels for an aviation interior, since the laminate needs to form to the overall shape, but not to the small surface imperfections on the substrate of the sidewall panel. The desired appearance is therefore achievable without the need for sanding and/or additional preparation work on the sidewall panels before application of the laminate, thereby eliminating or reducing manual labor and effort in applying the laminate.

The laminate decorative layer or layers may be formed of thermoplastic resin materials that can be screen printed or otherwise provided with graphics and/or colors. With some thermoset polyimide films, the film may have a yellow amber color, which may affect the decorative appearance of the laminate. In association with a layer of the laminate on top of the thermoset polyimide layer, an amount of titanium dioxide (0.1% to 20% by weight) may be added to mask the color of the thermoset polyimide layer. This will act as an opaque white layer blocking and shielding the thermoset polyimide layer and any appearance of the thermoset polyimide showing through to the decorative laminate surface. The first protective outer layer of laminate forms an exterior surface that can be cleaned and is resistant to cleaning compounds. The ratio of the thicknesses of each laminate layer as well as the overall thickness of the laminate will be dependent upon the required performance characteristics of the end-use in addition to the specific thermoplastic polymers employed in each of the layers in combination with the at least one layer of thermoset polyimide. For example, films such as Tedlar® or Mylar® films from DuPont may be used in the laminate construction in conjunction with the at least one thermoset polyimide layer. Other materials usable in laminates may include poly(vinyl chloride (PVC) based materials, poly(vinylidene fluoride) (PVDF) based materials or blends of PVDF with other polymers may also be used. To reduce weight, foams may be used in the construction of laminate. Suitable adhesives and primers may be used in the construction of the laminate.

It is also an aspect of the invention that the laminate products, may be formed in a continuous belt type process, and subjecting the laminate web to heat and pressure as it is moved along a line, by a continuous press machine for example. The continuous web material could then be cut or further processed as desired.

As the laminate of the invention provides a range of benefits that contribute to the overall enhancement of aerospace interior laminates, it can be tailored for various specific applications. Due to the possible substantial weight reduction achieved by replacing conventional flame-retardant thermoplastic films and flame-retardant additives with at least one layer of thermoset polyimide in the laminate construction, additional thickness of the thermoset polyimide or embossing resin may be used to achieve desired performance characteristics. The laminate construction provides proper texture retention in the thin film laminate, and desired texture depth to provide the desired visual appeal. The laminate provides a reduction of the density and weight, to allow use of thicker embossing resin layer(s) while maintaining a desired overall thickness. This weight reduction allows the laminate to meet stringent weight requirements more easily in aerospace interior laminates while ensuring the necessary flame-retardant levels are maintained. The improved flammability also allows tailoring of the laminate for various applications, with further flame retardant materials added while maintaining desired thickness and weight. This reduction in flame-retardant levels, combined with the weight reduction provide the ability to use lighter products with deeper textures that are also highly flame-resistant.

In the foregoing description of various embodiments of the present disclosure have been presented for the purpose of illustration and description. They are not intended to be exhaustive or to limit the invention to the precise forms disclosed, and modifications or variations are contemplated to generate a wide variety of designs in a laminate construction for use in aerospace or like passenger compartment interiors, that meets the stringent requirements of such transportation vehicles while enhancing the appearance of the interior compartments. The various examples are illustrations of the laminate, with other constructions possible within the scope of the invention. Thus, all such modifications and variations are within the scope of the present disclosure as determined by the appended claims.

What is claimed is:

1. A laminate comprising a plurality of layers forming a sheet having decorative features selected from textures, three-dimensional depth or combinations thereof, the plurality of layers including a base layer with a predetermined thickness to serve as a backing for application to a surface, at least one intermediate layer with a predetermined thickness forming to allow forming of decorative features, textures, three-dimensional depth or combinations thereof in the laminate, and a top protective layer of thermoplastic material having a predetermined thickness, wherein at least one layer of thermoset polyimide having a predetermined thickness is provided below the intermediate layer, wherein the laminate has predetermined combustion reaction properties of smoke density, smoke toxicity, resistance to sustained ignition and heat release properties for use in a commercial passenger vehicle interiors.

2. The laminate of claim 1, wherein the at least one layer of thermoset polyimide is the base layer of the laminate.

3. The laminate of claim 1, wherein at least one layer of thermoset polyimide has a thickness of between 0.5 to 10.0 mils, with the thickness being variable to provide predetermined performance characteristics selected from the group consisting of tear resistance, tensile strength, dimensional stability, weight of the laminate or combinations thereof.

4. The laminate of claim 2, wherein a layer of adhesive is provided on the base layer for application to a substrate surface.

5. The laminate of claim 1, wherein the intermediate layer is formed of embossing resin having a thickness to allow at least one different depth portion to be formed in the laminate top surface.

6. The laminate of claim 1, wherein the intermediate layer is formed of embossing resin having a thickness of between 1.5 mils up to 8.0 mils.

7. The laminate of claim 6, wherein the embossing resin layer has a thickness of at least 4.0 mils.

8. The laminate of claim 1, wherein the at least one layer of thermoset polyimide has a thermal decomposition temperature in the range of 500° C. to 600° C. (932° F. to 1112° F.), and no glass transition temperature.

9. The laminate of claim 1, wherein the base layer is formed of an embossing resin with a predetermined thickness, and the at least one thermoset polyimide layer is provided on top of the base layer, and wherein the intermediate layer is provided on top of the at least one thermoset polyimide layer.

10. The laminate of claim 9, wherein the intermediate layer is an embossing resin layer having a predetermined thickness to allow forming of decorative features, textures, three-dimensional depth, or combinations thereof in the laminate.

11. The laminate of claim 1, wherein the base layer is formed of a thermoplastic formable substrate and a layer of adhesive is provided on the base layer with an embossing resin layer with a predetermined thickness provided on the adhesive layer, and the at least one thermoset polyimide layer is provided on top of the embossing resin layer, and wherein the intermediate layer is provided on top of the at least one thermoset polyimide layer.

12. The laminate of claim 11, wherein the intermediate layer is an embossing resin layer having a predetermined thickness to allow forming of decorative features, textures, three-dimensional depth, or combinations thereof in the laminate.

13. The laminate of claim 1, wherein the base layer is formed of a glass reinforced prepreg and the at least one thermoset polyimide layer is provided on top of the glass reinforced prepreg layer, and wherein the intermediate layer is provided on top of the at least one thermoset polyimide layer and is formed of an embossing resin having a predetermined thickness to allow forming of decorative features, textures, three-dimensional depth, or combinations thereof in the laminate.

14. The laminate of claim 1, wherein the base layer is formed of a glass reinforced prepreg and a layer of glass with resin is provided on the base layer with the at least one thermoset polyimide layer provided on top of the glass with resin layer, and wherein the intermediate layer is provided on top of the at least one thermoset polyimide layer and is formed of an embossing resin having a predetermined thickness to allow forming of decorative features, textures, three-dimensional depth or combinations thereof in the laminate.

15. The laminate of claim 1, wherein the laminate has a total and peak heat release, as measured by the OSU heat release test, of less than 55 kW/m² for peak heat release and 55 kW·min/m² for total heat release and the measurement of smoke release according to the FAR 25.853, Appendix F, Parts IV and V is less than 200.

16. The laminate of claim 1, wherein the thermoset polyimide has a density range of 1.3 to 1.5 g/cm³, and the use of other flame retardant layers in the laminate is reduced or eliminated while total and peak heat release, as measured by the OSU heat release test, is less than 65 kW/m² for peak heat release and 65 kW·min/m² for total heat release and the measurement of smoke release according to the FAR 25.853, Appendix F, Parts IV and V is less than 200.

17. The laminate of claim 1, wherein the weight per unit area of the laminate is less than 260 g/m² as measured under ISO 3801 method 5.

18. The laminate of claim 1, wherein the laminate has a tensile strength of least 175 N/25 mm.

19. The laminate of claim 1, wherein the laminate is formable in a dome mold thermoforming test at a vacuum pressure of 4 in Hg using the thermoforming temperatures between 70° C. to 225° C., to a depth of at least a 3.0 inch draw using a thermoset polyimide layer having a thickness of 2.0 mil (0.0508 mm) or less, with the laminate having weight per area range of 150 to 700 g/m².

20. A decorative laminate comprising a plurality of layers forming a sheet with a base layer to serve as a backing for application to a surface, at least one intermediate layer and a top layer, with at least one layer of a thermoset polyimide with a thickness of between 0.5 to 10.0 mils and the at least one intermediate layer including a layer of embossing resin disposed between the at least one layer of a thermoset polyimide and the top layer with a thickness of between 1.0 to 60.0 mils, wherein at least one layer of thermoset polyimide has a thermal decomposition temperature in the range of 500° C. to 600° C. (932° F. to 1112° F.) and no glass transition temperature.
